(19) United States
(12) Patent Application Publication
(10) Pub. No.: US 2016/0052621 A1
(43) Pub. Date: Feb. 25, 2016

(54) ENERGY EFFICIENCY IMPROVEMENTS FOR TURBOMACHINERY

(71) Applicants: Peter IRELAND, New South Wales (AU); Anthony IRELAND, Lynn Haven, FL (US)

(72) Inventors: Peter S. IRELAND, New South Wales (AU); Anthony IRELAND, Lynn Haven, FL (US)

(21) Appl. No.: 14/392,056

(22) PCT Filed: Jan. 25, 2013
(86) PCT No.: PCT/IB2013/050676

§ 371 Date: Jul. 13, 2015

(51) Int. Cl. B64C 23/06; F04D 29/68; F01D 5/14

(52) U.S. Cl. CPC B64C 23/06; F01D 5/145; F04D 29/681; F05D 2240/303; F05D 2240/35; F05D 2240/121

(57) ABSTRACT

A method and apparatus are disclosed that allow Conformal Vortex Generator art to improve energy efficiency and control capabilities at many points in a turbomachine or device processing aero/hydrodynamic Newtonian fluid-flows.

### CROSS-REFERENCE TO RELATED APPLICATIONS

This application is a continuation-in-part of US National stage application US2011/0006165A1 filed Jul. 8, 2010, which is the non-provisional application derived from provisional U.S. application 61/224,481 filed Jul. 10, 2009, also filed as International application PCT/IB2010/001885 on Jul. 9, 2010.

### TECHNICAL FIELD

This invention is in the field of devices processing aero/hydrodynamic Newtonian fluid-flows and the ability to improve their energy efficiency and/or performance envelope by employing the novel fluid dynamics structure of a conformal vortex generator (CVG). This novel application of embedded or integrated CVGs typically operates in a multiplicity of places and roles, like; actuator discs, foil cascades and flow-control surfaces in dynamic turbomachinery such as mobile turbine engines, static power generation turbines, helicopters, wings, and other Newtonian fluid-flow applications.

### BACKGROUND ART

Additive CVG's employed for e.g. a helicopter Erosion Protection System (EPS) are not feasible to adhere to and match smaller and more complex and intricate turbomachinery structures with very high radial accelerations, in the order of tens of thousands of gravities, that require new inherently embedded or integrated CVG methods for; cascades of high solidity and demanding performance environments, such as high temperatures and sharp edged input surfaces. Additive CVG's are opportunistically adhered with an adhesive to an existing foil or body surface design, post-manufacture, where the original foil or body surface design-intent or engineering considerations were not adjusted for the best incorporation of CVG benefits. Integrated CVG art, on the other hand is included in the design process and engineering for the new foil or fluid-flow control surface design, and this allows new combinations of capability, performance, fluid-flow control ranges, energy efficiency and manufacturing choices not possible with additive CVG art.

The gas turbine engine is a well-known example of a complex turbomachine that employs a wide range of Newtonian fluid-flow, thermodynamics, materials and physical techniques applied to a real fluid-flow processing device. Each of the sequential functional blocks accepts some input fluid-flow, processes this fluid in some manner and then outputs this fluid at an interface to the next stage of the engine. The initial air intake is the first fluid input interface, and any cold or hot section exhaust nozzles complete the final fluid output interface(s) into ambient atmosphere. For turbine engines employing the well-known Brayton-cycle, efficiency is related to the well-known theoretical thermodynamic cycle performance of the ratios of the fluid peak working temperature to final exit temperature differences and the flow efficiencies, or energy losses, of the compressor, turbine, combustor and inlet guide vanes (IGV), flow ducting and exit nozzle gas paths.

In this disclosure, the fluid-flows taught herein are of a working Newtonian “fluid”, typically atmosphere or other gas, but numerous CVG technology embodiment examples are also valid for a liquid or mixed-phase state when Reynolds numbers (Re) are accounted for. This is known to be true, since numerous foil and flow designs for gas fluid-flows in turbomachines and devices are scaled, tested and flow visualized for convenience in e.g. water tanks employing marking materials and methods to observe scalable fluid-flow effects. Hereinafter “fluid-flow” is applicable to either Newtonian gas and/or liquid phases as the fluid dynamics are adjusted to the actual fluid-flow conditions and Re numbers.

Engine compressor and turbine blade stator and rotor disc designs, as an array of foils in a cascade, are optimized for aerodynamic performance, engine geometries and mass flows. The “cold section”, of compressor and possible bypass-fan stages and ducting operate in a somewhat less demanding environment, since the early stages operate closer to the cooler inlet fluid temperatures. Flow improvements in these cold sections do not have the complexity of high gas temperatures affecting material strengths, oxidation or other problems, to compound the common; rotational, flow, aeroelastic, vibrational, fatigue and pressure stresses. Compressor stages may absorb about 60%+ of the total provided fuel-energy, and this is extracted by turbine stages. Efficiency improvements in the remaining available turbine output energy and jet exhaust nozzle impulse have a high effect on the useful output work available.

### DESCRIPTION OF PRIOR ART

Low Pressure Turbine (LPT) stages: On modern multiple concentric-shafted engine designs, typically the LPT stage extracts energy from the mass flow of exiting post-combustor “hot section” gasses, inducing a pressure drop, and conducts this energy via the innermost axial drive shaft to the bypass-fan, shaft loads and/or the initial compressor stages.

As blade loadings and Zweifel loading coefficients of LPT stages have been increased to; modify cascade solidity, lower blade counts, engine size, weight and cost, a problem emerges with the aerodynamics of impulse/reaction foils in a turbine cascade. At lower Re numbers “off-design” the rotor and stator blades can experience adverse suction-face pressure gradients that induce; thickening of the Boundary Layer (BL), transition to turbulent fluid-flow, fluid-flow separation in lower momentum BL layers, total fluid-flow separation bubbles and loss of energy efficiency.

McQuilling teaches in his thesis “Design and Validation of a High-lift Low-Pressure Turbine blade” that “higher lift” (and front loaded) LPT blade designs like his proposed L2F with improved Zweifel coefficients over common examples like the well-known Pratt and Whitney Inc. ‘Pack-B’ blade designs, are possible without employing any additional flow-modification methods to counteract flow separation or blade stalling at operating envelope extremes or “off-design”.

Here, blade foil front-loading optimizations allow suction-face pressure recovery to be spread over a longer chord distance, so adverse pressure gradient is reduced, improving fluid-flow and reducing separation of low energy and low momentum lower BL. In this case, the basic blade fluid-flows, reactions to unsteady upstream wakes etc. can be designed to be improved over the prior art, but the ultimate combined performance improvement is to optimize the design blade loading and to also employ flow improvement techniques to lower drag and separation, particularly off design at the performance envelope limits.

Fluid-flow modification examples and effects are summarized and taught by e.g. Rouser, in the thesis “Use Of Dimples To Suppress Boundary Layer Separation On A Low Pressure Turbine Blade”, and include numerous types of surface structures and methods employed to primarily generate vortex flows and convect energy from the higher-momentum flow layers down into the lower layers (closer to foil surfaces) to reenergize the lowest BL levels and forestall adverse pressure gradient effects and fluid-flow separation from foil surfaces.

Well-known Vortex generators (VG) employed to improve foil flows fall into a number of categories with differing effects and benefits. Protruding devices such as; ramps, angled vanes, riblets, Wheeler ramp vortex generators and similar produce beneficial vortices, but generate extra drag while attempting to change BL flow conditions that would tend to lower drag and flow separation losses. Additionally, these protruding devices harvest energy from the more energetic upper-layers of the thickened BL or free-stream at lower Re numbers, but then protrude high above the thinner BL at higher Re numbers, and cause high induced drag at this performance point. These devices are characterized as having heights of a significant fraction of the BL thickness, in the e.g. 35-100% or greater range of the maximum BL at the VG.

Recessed or submerged VG's and micro-VG's such as; Ogee submerged, Wheeler channel or even dimples, at less than a BL depth have been widely researched and taught to generate less added drag than protruding type VG's. These devices have a varying geometry or height at the step or ramp, in the chordwise direction. The Ogee submerged devices present their apex toward the incoming fluid-flow and do not conform to the foil profile. For some micro-VG's low in the BL, the complexity of serial application is required to generate sufficient vortex energy, and in a rotating environment like a blade this close-proximity application is adverse to performance.

Dimples are typically a simple and omnidirectional device, that as Rouser teaches, do lower drag by suppressing large flow separation bubbles (as used e.g. to allow golf balls to fly farther due to lowered drag). However, the dimple shedding vortices are complex with less than optimum intensity or capability of coupling much freestream fluid-flow energy into the lower BL. Dimples for BL control are complex because performance is sensitive to geometry and Re number as to which vortex modes are predominant. Blade type VG's have an additional problem in that for the e.g. Re numbers of real LPT blades, they become very small, in order of millimeter dimensions and hence very sharp, fine and delicate structures and also subject to particle erosion and damage by oxidizing hot exhaust gases. Further problems are the mechanical effects on blade fatigue due to point stress concentrations during blade flexure, and the risk these sharp objects pose to maintenance personnel.

Ramp-entry (e.g. Wheeler, upwards ramp flow with aft facing step) and ramp-exit type (e.g. Ogee submerged, downwards ramp flow with forward facing step) VG's also have other secondary flow structures and potential shock waves, such as across flow or spanwise horseshoe vortices that divert energy from being strongly coupled into exiting chordwise vortices. NASA research shows conventional VG's produce vortices that typically persist in the flow direction for a distance of about 30 times the VG height, to at best about 40 VG height multiples rearward along the chord length, and end up convecting away from the foil surface into the higher energy layers.

Rouser also teaches other non-VG methods of BL flow control, such that shown in his FIG. 10, (attributed to McCormick) as passive porous-surface devices, where higher pressure air is created and injected onto the surface of the low pressure area before separation, through an array of holes or injection slots or steps. This performs similar effects to the Coanda or other lift enhancing or blown-flap type methods, or other suction methods being used to stabilize BL areas. Of course one of the problems with jet fluid injection is balancing the BL and jet momenta, to avoid jet “lift-off” or flow separation as the BL velocity reduces, or varying flow Re, and additionally the local BL is disrupted to form a horseshoe vortex around the leading edge (LE) of the jet fluid-flux column or stream before it can be driven closer to the blade surface.

The reported Hybrid Laminar Flow Control (HLFC) on the Boeing 787 airliner employs a porous suction-surface art for BL control on the LE of the vertical stabilizer to improve control flow separation (in lieu of VG's) during e.g. single-engine operation, employing suction air from a passive source. The usage of a porous hole/mesh suction surface has the problem of the environment clogging the inlets, viscous energy losses, power required to induce suction, along with a strength compromise to the composite structure.

Stephens in U.S. Pat. (U.S. Pat. No.) 2,800,291, Wheeler in U.S. Pat. No. 4,455,045 and U.S. Pat. No. 5,058,837, Rinker in U.S. Pat. No. 7,900,871, and numerous others all teach variations of add-on ramp style VG's or similar discrete shapes that begin with a thin (non-zero) entry edge and then extend rearwards in the fluid-flow as a ramp with an apex at an increased height away from the underlying foil surface. Geometrically or morphologically these devices are not conformal to the surface of the underlying foil in any interpretation. As taught in Stephens '291, excrescences or equivalent VG structures like Rinker '871 cannot act as drag reducing at foil or body surface low Angle of Attack (AoA). Herein “low AoA” is defined as the included range of positive, zero and negative AoA's below which angle magnitude there are no significant fluid-flow separations (e.g. stalling) or detachment bubbles on the foil or body surface, upstream of any conventional final exit flow separations at e.g. the fluid-flow exit, or TE where the Kutta-Joukowski conditions are met. For most foils a range of +/−4 degrees AoA would meet this condition, but this is not limiting and in cases may be a greater range, and approach the stall AoA. Schenk in U.S. Pat. No. 4,354,648 teaches arrays of protruding low-profile BL tripping devices to generate BL turbulence and reduce airfoil flow-detachment on a wing. Schenk '648 devices are not zero entry-height and are not fully conformal to the foil surface, so they induce drag from horseshoe vortices and turbulence even though they are suggested as smaller than prior art VG's. The small size, discontinuous or point coverage and non-directional turbulence is not an efficient BL reenergization method.

Vijgen et al. in U.S. Pat. No. 5,088,665 teach a modification at a foil trailing edge (TE) with the addition after the TE of a serrated panel or a triangular/saw-tooth array of elements to “improve lift and drag characteristics”. The addition of extra active aerodynamic elements outside the physical extent of the original base foil is distinctly different from adding CVG's onto to the foil surface ahead of the TE and within the original foil physical extent or boundary. Fritz in U.S. Pat. No. 8,083,488 also teaches an add-on panel of serrations at the TE, and is distinct and patentable over Vijgen '665. Shibata in U.S. Pat. No. 6,830,436 teaches and claims a wind turbine blade with “dentations” or serrations added at the TE to both reduce noise and increase efficiency, by modifying the trailing von Karman Street vortex sheet. Gliebe in U.S. Pat. No. 6,733,240 also teaches and claims a serrated TE arrangement on a turbofan blade to improve flow mixing and reduce noise, and employs the same aerodynamic effect and results as taught by Young in U.S. Pat. No. 3,153,319 and Balzer in U.S. Pat. No. 6,612,106. Gliebe '240 does not teach a drag reduction below baseline design, disturbs the linear TE and is clearly distinguishable from CVG's that are simply added on the foil before the TE to obtain drag reduction over baseline configuration, and other improvements.

Godsk in U.S. Pat. No. 7,914,259, teach employing several rows of discrete prior art VG's along wind turbine blades to extend baseline unstalled AoA from about +10 degrees to about +16 degrees with VG's added, as shown by his FIG. 3. The Godsk '259 FIG. 4 shows the well-known problem with discrete ramp and blade VG's that at low AoA's, and up to about the +10 degree baseline stall AoA, the VG equipped blade has higher Coefficient of Drag (C_{d}) than a baseline unmodified blade.

Wortman in U.S. Pat. No. 5,069,402 teaches using large prior art blade-type VG's to generate vortices that then propagate along a diverging-flow surface like the upsweep of a C-130 tail section, to prevent or reduce flow separation (similar to stalling) from surfaces that effectively have a high AoA or divergence from the fluid-flow streamlines, that would ordinarily create large downstream eddies and high induced drag. The Wortman '402 art blade VG's themselves develop significant form-drag in operation, but act to lower the much larger downstream separation drag, so appear to be overall drag-reducing, when in fact these VG's induce drag and can only appear as relatively reducing drag in a scenario of modifying another significant separated or stalled flow.

Ramp and blade VG's tend to generate non-persistent vortices higher in BL that are not bound to the foil surfaces. Dimples and bumps create vortices, but these are not highly efficient or energetic, and bumps have the same issue as blade VG's, of inducing excess drag in the higher BL as the Re numbers change and the BL thins.

Martin, McVeigh et al. in the AIAA paper “Passive Control of Compressible Dynamic Stall” teach in their FIG. 27 that small blade VG's employed on helicopter rotor blades increase blade C_{d} from about 0.01 to about 0.015, which significantly increases rotor power requirements by about 50%, whilst reducing dynamic stall and blade pitching moments due to the VG's increasing the blade stall AoA. McVeigh in U.S. Pat. No. 7,748,958 claims this VG structure and method for reducing dynamic blade stall/pitching moment, but cannot claim addition of absolute drag reducing capability, based on published test results and known flow physics.

Volino in a NASA research report “Synthetic Vortex Generator Jets Used to Control Separation on Low-Pressure Turbine Airfoils ” teaches active separation control using synthetic vortex generator jets (VGJs), where vortices are created by pulsing angled jet flows into the BL which induce partially chordwise vortex flows and help in a similar manner to conventional VG's in reducing flow separation bubbles. Volino's approach is unique in that the design creates the pulsed jet flows with no-net-flow acoustic generation, so as not to require a constant source of energizing blower fluid-flows that cost energy to generate. The interaction of the fluid jet and higher BL flow and momentum layers generates vorticity but this also generates drag while trying to spread energy more widely spanwise into the following BL areas.

However, all these prior art plans to improve airfoil or LPT blade flows and reduce separation have an issue, in that a real world rotating environment imposes extra, complex conditions that can cause vortices higher up in the boundary layers to convect outward in the foil spanwise direction. This is due to the fact that centripetal forces tend to spin vortices not tightly bound to the surface outward (radially towards tip) after the physically defined point of generation into higher BL fluid-flow patterns, since there is no significant force acting to attach them closely to the blade as it accelerates in a curved path, and additionally as the vortices tend to move downstream they can convect to the top of the BL they can intercept any spanwise secondary flows and also get strongly disrupted outboard.

In this case the beneficial intent of the chordwise vortices generated earlier on the chord to re-energize the BL and reduce flow separation and drag actually becomes adverse, as shown by Martin et al., and the vortices precess to act partially transverse to the free stream (vortex axis more in a spanwise direction) in a chaotic way which tends to thicken the following BL and increase drag, while having some effect on separation. This effect has been clearly demonstrated on helicopter rotor blades operating at about 1,200 gravity acceleration at the tips, a significantly lower centripetal acceleration than the LPT cascade operating environment. Prior art vortex generators acting or convecting vortices above the BL are generally adverse in a rotating environment, as shown by Martin et. al.

Aft-facing steps spanwise to freestream flow are known to generate trapped vortices and hence fluid losses and flow disturbances, as taught by Calvert and Wong, in the AIAA paper “Aerodynamic Impacts of Helicopter Blade Erosion Coatings”. They teach that spanwise vortices on a simple aft-facing step (i.e. at 90 degrees to fluid-flow), such as that on a helicopter LE erosion protection strip (EPS) of a UH-60 are known to increase blade drag by about +5% or more, depending on blade operating points.

In the UH-60 case, an aft-facing step of e.g. ˜0.5mm height and 5 meters length would imply a trapped spanwise step-vortex filament with an aspect-ratio of about ten-thousand, and in a fluid dynamics situation this very slender vortex filament structure is not dynamically stable. In the LE part of a rotating foil like an e.g. helicopter there are numerous mechanisms that strongly perturb BL level fluid-flows. The spanwise (or generally radial) secondary above-BL flows tend to drive an outboard shear force on lower BL momentum layers so they flow at an angle to the foil chord, and hence angled across the EPS step. This provides a strong step-vortex breakup impetus, along with centripetal accelerations on the viscously attached BL layers tracking the foil motion, which can force sections of the step-vortex to continuously shed in vortex sections that can precess to be angled to the span and perturb and thicken the following BL on the foil and increase drag losses, as are measured. In the LE upstream laminar-flow regions Tollmien-Schlictig (TS) acoustic pressure waves develop, are amplified, stream rearwards and aid in transition to BL turbulence and hairpin vortex streams, and these disturbances also affect the step-vortex stability and shedding frequencies. It is an unexpected result to be able to employ an aft-facing step arrangement to generate a drag reduction, lower energy losses and improve fluid-flow efficiency over a baseline or unmodified fluid-flow surface.

Stephens '291, Wheeler '045 and '837, Rinker '871, Vijgen '665 etc., and all other known prior art typically show forms of vortex generators with generally triangular shapes and apparent visual similarity, but it is readily shown by aerodynamic analysis that their form and effects are clearly distinguishable from the new art of CVG's.

High Pressure turbine (HPT) stages: As Turbine Inlet Temperature (TIT) from combustors has increased, giving rise to; better, lighter engines and improved specific fuel consumption (SFC) a point is reached where no Nickel based super alloys can directly withstand the hot gas temperatures, and other methods are needed to actively cool and maintain shape and strength of engine components under operating loads. Typical designs employ bleed compressor cooling-air; to cool the combustor, HPT stators and rotors and duct surfaces to the point the flow temperature has reduced safely, and may also employ e.g. ceramic thermal barrier coat (TBC) to minimize cooling energy-costs. TBC's reduce the cooling requirements and related energy costs because surface thermal resistance is increased, but the remaining heat flux has to be removed so the base metals are kept cool enough not to be softened or have their alloy crystalline arrangements dislocated.

HPT cooling: It is well known that on hot-section duct surfaces and blades (both rotors and stators) that excess mix-down or turbulence of the higher and hotter gas flows into the lower BL causes increased heat flux loading on component surfaces subject to hot gas flows, and increased cooling requirements. Thus adverse fluid-flow separation and turbulence are both efficiency (drag) and thermal durability problems.

Examples of prior art are, Howald in U.S. Pat. No. 3,527,543 who teaches surface film-cooling using holes on blade to conduct internal cooling air onto blade surface. Bird et al. in U.S. Pat. No. 5,193,975 teach a turbine blade with internal cooling passages, pin cooling and TE slot cooling air ejection. The ejection slot straight-edges are typically adverse to drag because an adverse vortex will form there at right angles to the flow if the main flows and cooling flow velocities are not matched and the slot flow separating edge does not to taper to a very (delicate) sharp edge. Zelesky in U.S. Pat. No. 5,378,108 teaches a TE series of slots modified to optimally distribute TE cooling flows and a thin TE defined by just the suction-face wall thickness, to minimize drag. Green in U.S. Pat. No. 5,374,162 teaches a blade LE fountainhead cooling that is effective for varying input flow angles. Lee et al. in U.S. Pat. No. 7,011,502 teach a LE bridge casting arrangement with pin meshes and cooling exit slots, but the exit slots still have the linear edge problem with an adverse spanwise vortex if merging fluid-flows are not matched and edges sharp.

Shih and Na in the ASME paper “Increasing Adiabatic Film-Cooling Effectiveness by Using an Upstream Ramp” teach improving the adiabatic film cooling effectiveness of up to a factor of three by employing a ramp forward of a cooling jet exit hole, instead of VG's incorporated within or at the jet holes. Here, a spanwise (across the free-stream flow) vortex trapped behind the ramp acts to modify the cooling fluid jet flow by disrupting the jet's adverse leading horseshoe vortex so as to spread coolant mass across the flow span, and before, the jet exit hole to improve cooling laterally or spanwise. This ramp/jet configuration shows about a three times more effective adiabatic cooling due to the ramp, but a protruding ramp structure as noted before is adverse, in that form or pressure drag is increased over the flat plate baseline. A ramp projecting into the hotter gas layers would also require the added mass of a TBC, as they note.

So the Shih and Na ramp and step idea with trapped spanwise vortices helping spread the cooling fluid, trades cooling improvements for adverse fluid-flow drag efficiency and viscous losses. The modeling was configured for the ramp to generate only spanwise vortices and no chordwise vortices at the ramp edges, like a Wheeler V G. Heidmann as reported by NASA in “A Numerical Study of Anti-Vortex Film Cooling Designs at High Blowing Ratio,” teaches an “anti-vortex” pair of smaller upstream jets that act to minimize the adverse kidney-vortices of a main cooling jet flow. This method to tries to spread the adiabatic cooling spanwise and avoid jet-liftoff where the jet flow separates from the surface, but is not taught as a combination that reduces foil drag losses or turbine drag efficiency.

Turbulators can also be configured as triangles, ramps, chevrons etc., inside coolant pipe flows, and the inside serpentine cooling passages of cooled High Pressure Turbine (HPT) rotor blades, stators and hot gas flow surfaces. In this case the flow geometry is configured, unlike CVG's, to provide maximum flow turbulence to mix heated surface BL fluids back up into the cooling core fluid-flows to maximize heat transfer or thermal conductivity and cooling efficiency, irrespective of drag induced. Here the surface steps or chevron vortex and turbulence-inducing structures are configured aerodynamically close together so the cooling fluid does not re-organize into smoother flows as the vorticity decays. Clearly this is not a low-drag manipulation of the fluid-flows and turbulent flow BL separation is actually being enhanced to improve heat transport by the working fluid, so these prior art structures are distinctly unlike CVG's.

HPT thermal barrier performance: Terry in U.S. Pat. No. 2,757,105 and Haskell in U.S. Pat. No. 5,260,099 teach the value of engine blade coatings, and Driver in U.S. Pat. No. 4,303,693 teaches a plasma spray coating method. Kojima et al. in U.S. Pat. No. 5,630,314 teach a ‘tiled’ or columnar thermal barrier coat (TBC) for turbine blades, and Nissley et al. U.S. Pat. No. 5,705,231 teach a pre-cracked or segmented plasma sprayed ceramic coating that has good abrasion and spalling resistance at gas turbine temperatures. Nissley and prior art also teach the value of intervening diffused or surface bond coats (e.g. MCrAlY, Aluminide, alumina, etc.) to; improve ceramic adhesion, improve thermal expansion coefficient matching, provide a malleable transition layer and provide increased thermal oxidation protection to the base layer of e.g. nickel super alloys typically used in high mechanical and thermal stress components.

Spengler et al. in U.S. Pat. No. 4,576,874 teach applying one or more ceramic TBC layers to a turbine blade to improve durability, and in particular applying the ceramic at elevated temperatures closer to operating conditions so when cycled to a cooler state the ceramic is in tension, and less likely to crack and spall. Strangman in U.S. Pat. No. 6,224,963 teaches the laser segmentation of a TBC to reduce spalling problems if a coating section is abraded or damaged mechanically. Thus an important issue to applying TBC's in turbine stages is resistance to mechanical damage, spalling and best matching of disparate thermal expansion coefficients to ensure best resistance to thermal, inertial loads and chemical corrosion effects.

Compressor performance: The efficiency of the compressor is important, and inherent BL control that can that can delay fluid-flow separation, allowing the stator and rotor blades to operate closer to their uncontrolled separation conditions, achieving a higher diffusion factor, higher turning-angle, higher blade loading allows a higher pressure rise per stage. Additionally a compressor has the problem that flow separation that propagates between multiple stages (stator/rotor disc pairs) can lead to complete fluid-flow breakdown, surging/power loss and in extremes, damage to the machinery.

Fluid-flow jets on the foil suction-face may be employed to reduce flow separations. Compressor rotor and stator blades are much thinner and less cambered sections than e.g. turbine stage foils, so the addition of internal flow galleries to allow fluid-flow harvesting for jets is challenging for fabrication, but in general, much of the central blade material is close to the neutral stress-axis, so some may be removed without significantly compromising section inertia or strength. Of course small flow ducts are susceptible to clogging and there is still the problem that jets can induce horseshoe vortices and can suffer lift-off if not controlled. Smaller jet engines often employ centrifugal type compressors in the high pressure stage prior to the combustors.

Fan stage: Fan rotor blades or actuator discs are typically fabricated in high strength Titanium or fiber reinforced plastic (FRP) as bladed fluid-flow structures that typically convert torque from the LPT stages into cold-section thrust that bypasses the engine core to augment the hot-section thrust at high multiple of e.g. 5 to 10:1 thrust ratios. FRP blades made of e.g. carbon fiber and epoxy or other resins (and even metal blades) are susceptible to LE erosion from rain, hail or sand or other ingested small FOD objects and even airborne volcanic ash, and are highly three dimensional (3D) contoured for best aerodynamic performance and laminar flows. Examples like the 123″/3.1 m diameter GE90 composite fan employ blades with a recessed bonded-on complex 3D shaped titanium machined LE strip to provide erosion protection and the ability to take in and survive FOD objects like bird impacts.

The interface between the LE EPS strips and the aft composite structure is a point that inevitably has small gaps that can develop by vibration or stress-induced edge debonding or erosion and then allow adverse spanwise vortices. The preferred flush LE strip provides minimum erosion protection to the painted surface immediately behind the transition which can then peel back in service, disrupting airflows and causing additional drag and energy losses.

All the arrangements of serrated foil or body TE's like e.g. Gliebe '240, like Stephens '291 item 13 also introduce mechanical stress focus-points on a stressed and necessarily thinnest foil TE aeroelastic surface, which can then become sites for fatigue-crack initiation and propagation.

Noise and LEBU: cold/hot duct flow mixing: Young '319 teaches many types of teeth and similar 3D arrangements to increase flow mixing, break up flow eddies and hence reduce flow velocity-gradients and noise generation mechanisms in the hot exhaust flows of a jet engine. Balzer '106 teaches exhaust nozzle chevron extensions to improve exhaust flow mixing to reduce engine noise. Boeing 787 engine nacelles employ Balzer '106 type serrations to reduce engine noise but the resultant flows are not acting on the BL attached to an aerodynamic body surface but at the free-stream boundary between a cold and hot fluid-flow stream, so these vortices are used for flow-mixing simply to reduce radiated acoustic noise spectra. This configuration is reported to lower noise but increase drag, as would be expected for vortices that do not improve BL flow re-laminarization but simply induce vortex fluid-flow momentum and losses.

Flow ducting in engine core: Lutjen et al. teach in application US #2011/0300342 that a metal substrate may be indented to form an array of pockets or blind recesses surrounded by elevated vertical portions (walls), which are then further modified by mechanical coining/deformation to form overhanging lips that are designed to then mechanically lock into and retain and stabilize a prior-art type of top-coated ceramic TBC. This is a derivative of the previous arts of “tiling” the ceramic into smaller sections to trap and retain cracked sections of the TBC so spalling and TBC loss is minimized.

Lutjen '342 teaches that his lower flat portion 50 of the indentation is specifically taught to be at right angles to the lip sidewall 54. This design has the issue that the taught right angle junction (i.e. a small radius of blending or transition) of loaded and vibrating mechanical sections forms a stress concentrator that acts to decrease fatigue life and provide a point for material cracking to start. Superior and different formed sidewalls with largest possible root radii allow the added local moment of inertia to be significantly increased, forming a stronger load-bearing beam extension from a loaded surface, which also supports this surface and helps minimize vibrational modes and flexure or deflections. Of course, large flow control surfaces that are curved in simple or compound manners will resist applied forces of pressure and inertial loads and have resistance to aero-elastic effects, but having the lip sidewalls helps improve structural efficiency (overall strength in all dimensions versus total mass) is useful, and that the Lutjen prior art forgoes . Flexure stress induced by vibration is adverse to reliable TBC “tile” attachment.

Additionally, Lutjen's formed retaining lips items 28 and 28′ are typically at the thinnest point in the final contoured smooth TBC coating (as in his FIGS. 5 and 6), and thus act to carry the largest heat loads conducting through the TBC from the hot gasses above. Here Lutjen's essentially straight sided indentation sidewalls 54 do not provide a minimum thermal resistance to a cooling fluid or gas below, as a larger wall root radius does, and so are not an optimal heat transfer configuration to keep the lip (wall top) metal areas with the highest heat stresses, at the lowest possible temperature for best metal strength and distortion/creep resistance. Lutjen '342 teaches the TBC protection applied to primarily static ducting surfaces but allows that the TBC can be added to other items requiring TBC protection, but only teaches thermal benefits and no absolute surface or form drag reduction properties.

Wennerstrom in U.S. Pat. No. 4,076,454 teaches the addition of blade VG's on the entry ducting into an axial flow compressor. He does not teach and cannot claim lowered ducting drag as a feature, and the VG's are claimed to act to help maintain unseparated fluid-flows on downstream blades, without any drag reduction benefit in the ducting or diffuser sections. The flow modification from the static rotor entry ducting is taught as having the vortices indirectly improve the flow separation characteristic of the downstream rotating compressor blades.

Nacelle and attachment pylon: The entry of the working fluid i.e. gases into a modern turbofan engine like e.g. a CFM-56 on a Boeing 737-600 is carefully engineered by the surrounding nacelle, and most nacelles act as an initial internal diverging-duct or diffuser to decelerate the incoming fluid-flow so that the first-stage Fan section and compressor stages can operate without their cascade blade-tips becoming supersonic and generating high-loss supersonic or Mach shock waves. At high wing/nacelle AoA, some of the nacelle initial internal diverging fluid-flow can separate from the internal nacelle walls, an adverse condition, or the amount of diffuser flow control employed must be limited so as to avoid this, or active suction control has to be added to the duct internal surface mitigate flow separations before the fan blades . The cold section ducting exiting from the fan section travels down a mix of diverging then converging ducts on inner and outer duct surfaces so can be subject to flow issues, such as Taylor-Gortler (TG) vortices on the concave sections. Crossing other aircraft vortex-wakes can also cause problems with transient flow attachment and surge etc., throughout the engine.

The Boeing 737-600, Airbus 319 and C-17 all teach modern examples of engine nacelles that use large blade or vane VG's at the approx. 2 o'clock and/or 10 o'clock location behind the nacelle outer entry LE to ensure external fluid-flows around the upper nacelle surfaces at high AoA stay attached and stream properly behind onto the attachment pylons and under and over the following wing as is required for minimum flow disruption and turbulence losses. At cruise these VG's are at minimum AoA since the vortices are not required, so have minimized form drag but always present additional form and wetted surface skin drags. Overall this configuration is not a minimum drag configuration to generate vortices to improve nacelle/pylon/wing/body flow interactions.

The nacelle/engine pylons are another area of flow interface issues and drag due to interference and secondary effects requiring fairing to control drag and fluid-flow losses. This is true for all attached aerodynamic bodies and devices external to e.g. wings or fuselage, such as; pylon mounted fuel tanks, wing tip tanks or other pods or structures such as VOR blade antennas, where aircraft pitch and yaw and secondary flow vortices can cause; adverse lift forces, flow separation, dynamic instabilities and flow interactions and drag. These issues are also present in hydrodynamic examples such as a hydrofoil wing with attachment legs or links, etc.

Leon in U.S. Pat. No. 5,156,362 teaches a retractable blade type VG for engine nacelle flow separation control. The blade upper edge is conformal to the nacelle and stream flow when retracted. When active the VG blade surface is at an angle to the flow and does not conform to the nacelle surface, and at cruise induces drag, which is why the retractable and mechanically complex feature is employed. This blade VG is many BL thicknesses in height to harvest maximum above-BL free-stream fluid-flow energy to induce strong vorticity effects when deployed.

### SUMMARY OF INVENTION

Improved energy efficiency and capability for turbomachinery, devices and processes that input a Newtonian fluid-flow, process it in some manner with CVG based fluid-flow modifying technology and then output this fluid-flow, is the goal of this invention. Processing means the addition or extraction of energy or work from this Newtonian fluid-flow, and/or deflection and modification of fluid-flow velocities, pressures and/or momentum.

It is an intent of the embodiments of this novel integrated CVG art to be “green” and allow reduction in energy usage and related carbon dioxide emissions.

Unlike prior art, new art integrated CVG's are an effective VG scheme in a cascade rotating environment that lower drag, particularly at low AoA values. Integrated CVG effects may be enhanced on foils or blades to passively induce additional BL fluid-flow energy over the larger suction-face aft foil to further delay separation, by employing harvested pressure-face fluid-flow, or other fluid sources, via flow control paths that are then directed to the suction-face to benefit stall or fluid-flow separation performance.

CVG's can be configured to improve output fluid-flow mixing and reduce flow noise without inducing added drag and energy losses. Engine nacelle, pylons and other aerodynamic body interfaces and surfaces are an area where drag reduction and improved flow control techniques also benefit from new CVG art.

Centrifugal compressors, and even mixed-flow types of impellers and diffusers, fluid pumps, turbochargers etc., benefit from BL flow control that minimizes fluid-flow separations using new integrated CVG art, which lowers; fluid-flow drag, flow separation/cavitation and generated acoustic noise on the impeller and diffuser blades and associated fluid-flow control structures.

Improvements in flow ducting and e.g. engine s-ducts are actually a case of general Newtonian fluid-flows in a pipe or other type of fluid-flow conduit or surface constraining means, (both internal and external flows) which allows the CVG flow control methods taught herein to be employed on the walls, surfaces, pipes, ducts and any flow control structures currently employed in prior art fluid-flow control surfaces.

Novel CVG structures produce persistent vortices without significant energy-consuming transverse flow structures, and channel maximum and selectable flow energy into vortices that tend to convect down towards the downstream fluid-flow surfaces that resist detachment. This provides a superior method to beneficially modify any surface and BL fluid-flows, to provide resistance to flow separation, lower absolute drag, and exhibit this lowered drag when operating in non-separated flow regimes and/or off-design situations. A basic integrated CVG structure demonstrates these properties, and when integrated into engines or fluid-flow control devices and surfaces can be configured to significantly improve upon the prior art, at numerous application locations and embodiments.

### BRIEF DESCRIPTION OF DRAWINGS (10 SHEETS)

All drawings are not to scale, but are detailed with many optional embodiment features, for illustrative purposes.

FIG. 1a details a representation of part of a Low Pressure Turbine stator or rotor blade with integrated CVG's embedded. FIG. 1b shows a pressure-face view of surface details of LPT integrated CVG's and FIG. 1c is a view looking at the suction or upper face including optional blade-tip CVG's and secondary CVG's.

FIG. 2a details a further example of a Low Pressure Turbine stator or rotor blade with integrated CVG's embedded, with a root end cross-section cut showing one embodiment example of the optional addition of suction-face extended flow control jets and step-vortex expansion grooves. FIG. 2b shows optional control-jet fluid source pickup(s) from pressure-face CVG valley and/or tip collection points. FIG. 2c shows a section across an angled suction-face aft-facing CVG step with airflow details.

FIG. 3 details an LPT stator or rotor blade with root hub fillets, and also shows modified; clipped, doubled and peak CVG tips along with asymmetric and extended CVG step configurations as well as contoured hub end-wall CVG's.

FIG. 4a details an example of part of a Low Pressure Compressor (LPC) stator or rotor blade suction-face with integrated ogival version CVG's embedded and a cross-section cut, along with options for additional jet-flow control. FIG. 4b shows part of an LPC stator or rotor blade pressure-face with optional; control-jet fluid source pickup(s) from pressure-face CVG valley and/or tip collection points. FIG. 4b also shows an ogival pressure-face CVG array version with a different pitch and offsets from the suction-face CVG array.

FIG. 5a details an example of a Fan blade suction face with a metal LE erosion protection strip and optional tip elastomeric Lift Enhancing Tab (eLET) to unload tip loads. FIG. 5b details an example of a Fan blade pressure face with optional; embedded CVG's, elastomeric Lift Enhancing Tabs (eLET's), tip CVG's and configuration example for additional jet-flow control.

FIG. 6a details an example of part of a cooled High Pressure Turbine stator or rotor blade suction-face with integrated CVG's embedded, showing optional; flow control and cooling jets and a secondary CVG array. FIG. 6b shows a HPT stator or rotor pressure-face and embedded CVG array with optional; flow control and cooling jets, secondary CVG array, TE pin cooling ejection-slot array and TE cooling enhancing tab array.

FIG. 7 details a centrifugal impeller and optional diffuser vane with integrated CVG's on flow control surfaces.

FIG. 8 details an engine nacelle, pylon and wing arrangement showing locations where CVG's may be employed to improve energy efficiency.

FIGS. 9a and 9b detail fluid-flow duct examples with CVG arrays added to improve flow and energy efficiency.

FIG. 10a shows integrated CVG steps and ribs embossed into a duct surface panel and optimized with integrated polygon structures on the shown “inside surface”. These polygons are configured and reinforced with large-radius (not right-angle) rib-bases for beam strength and high thermal conductivity to inside cooling flows with minimal material weight, and the opposite side of this panel has a resulting CVG step array (not shown) in the external fluid-flow, like the TBC CVG array in FIG. 10b.

FIG. 10b depicts an alternate version of FIG. 10a duct (or a blade) surface with an additional TBC applied and interlocked into the polygon array, with fluid-flows now on this TBC side. Film cooling and flow-attachment and BL improvement jets are also shown.

FIG. 11a is a cutaway drawing of a combustor design that employs CVG's to provide; lowered drag and energy losses and improved fuel injection and mixing. FIG. 11b shows an alternate embodiment employing a variation of a ceramic body and walls and CVG array to define the rich-burn aperture volumes.

### DESCRIPTION OF EMBODIMENTS

The best mode for carrying out this invention is an example of turbofan jet engine that teaches many typical areas and application methods that can benefit performance by application of properly configured integrated CVG's. A turbofan engine provides a quite large number of examples for useful integrated CVG applications, since it employs numerous fluid dynamics surfaces to manipulate Newtonian fluid-flows to generate useful work and effects. This example is just one form of fluid-flow machine that employs a gas as the working fluid, but most CVG methods can be adapted simply to many useful instances that employ liquid-phase or mixed-phase Newtonian physical fluids and get similar improvements for e.g. drag and separation/cavitation reduction, by scaling geometry to account for; velocities, pressures, Reynolds numbers, fluid phases (gas/liquid state transitions) and flow viscosities.

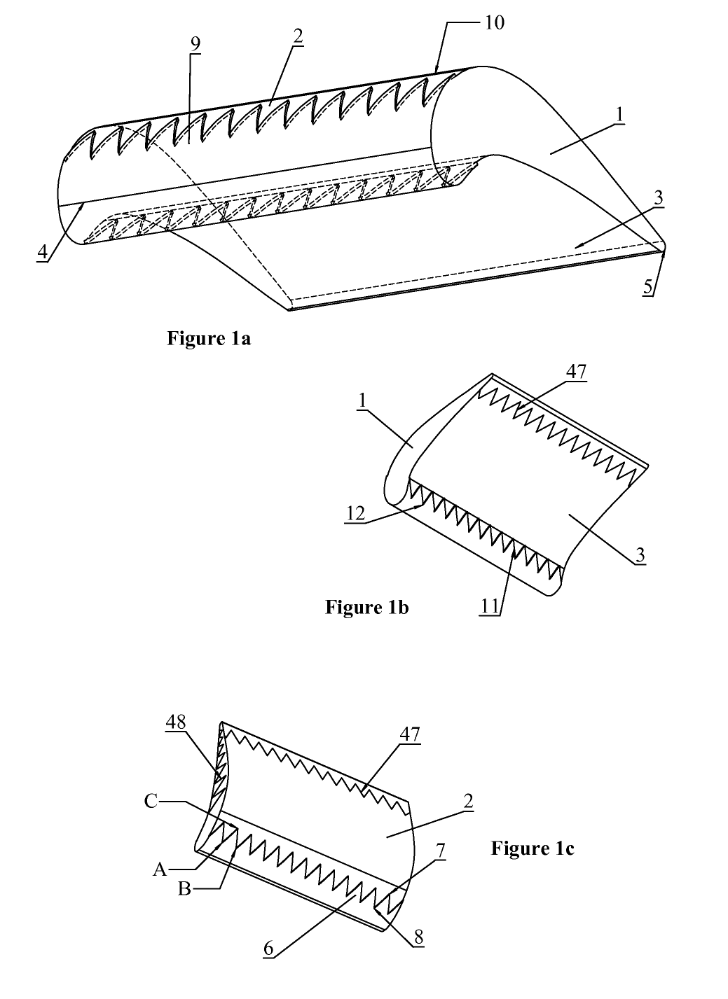

FIG. 1a item 1 depicts the root-end of a stylized example of an isolated Low Pressure Turbine (LPT) rotor or stator blade “bucket” with a deep cambered profile for reaction and impulse and diffuser action that is typically employed around a rotor or stator disc in a cascade arrangement. For presentation simplicity, this example is not twisted and/or tapered as typical, to provide; a constant-reaction velocity profile radially from combinations of rotor (reaction) and stator (diffuser) foils, and secondary flow control. The blade root attachments, hub and tip end-walls, and adjacent overlapping blades and upstream actuator discs are also omitted for clarity but are employed in a final design as known by those skilled in the art of cascade fluid dynamics.

Item 2 is the convex suction-face downstream surface and the concave pressure-face downstream surface is area 3. The fluid or hot gases arrive at the designed blade input-angle that defines the local foil or surface operating AoA, and the flow splits over the suction and pressure faces due to geometry and fluid dynamics forces at the LE stagnation line 4. For the rotor disc case, after performing work on the blade foils and generating force vectors (towards the suction-face side), the working fluid then exits at the designed output exit-angle at the trailing edge 5, (TE). Blade lift-forces that resolve tangentially around the turbine rotor axis generate torque output from the energy of the input fluid-flow and the resolved vector component in the rearward axial direction is drag or energy and adverse momentum loss that causes an additional pressure loss across the cascade section.

The on-design input-angle for an upstream input fluid source and output-angles for output fluid delivery after CVG processing, define the peak amount of energy that can be extracted from the input fluid source fluid-flows in the cascade section, assuming that the flow in this section is configured for minimum energy losses due to flow turbulence, separations and viscous losses at that operating point.

In some flow conditions with e.g. lower Re numbers off-design from optimum the suction faces experience flow separation after the pressure minimum, and this increases the cascade losses, reduces efficiency and increases engine SFC. Fluid stresses from centripetal accelerations while traversing a concave pressure-face 3 may also induce energy losses and BL thickening from e.g. TG vortex formation. Cooling is typically not required on LPT blades since the gas flow cools significantly through the HPT turbine sections and temperatures are then lower than e.g. Nickel superalloy blade materials can safely handle.

To help improve the flows across the suction-face it is beneficial to re-energize the boundary layer, BL, flow streamlines so they have sufficient momentum to remain flowing and attached close to the blade, in the adverse pressure recovery gradient after the suction pressure-peak line, 10, when deceleration of fluid-flow mass begins across the local surface due to flow conditions. To provide more flow energy into the downstream very lowest layers of the BL on the suction face, the upper Conformal Vortex Generator (CVG) array 6 is designed and fabricated, as integrated or embedded inherently at the forward part of the suction face in accelerated flow regions, and this structure is designed to convert a fraction of the accelerated incoming free-stream fluid-flow energy into a pair of intense counter-rotating vortices that stream backward from the array of upper CVG tips, 7, and that can provide suction-face separation control similar to conventional VG's, which cannot be practically employed in this environment of complex flows and small geometries.

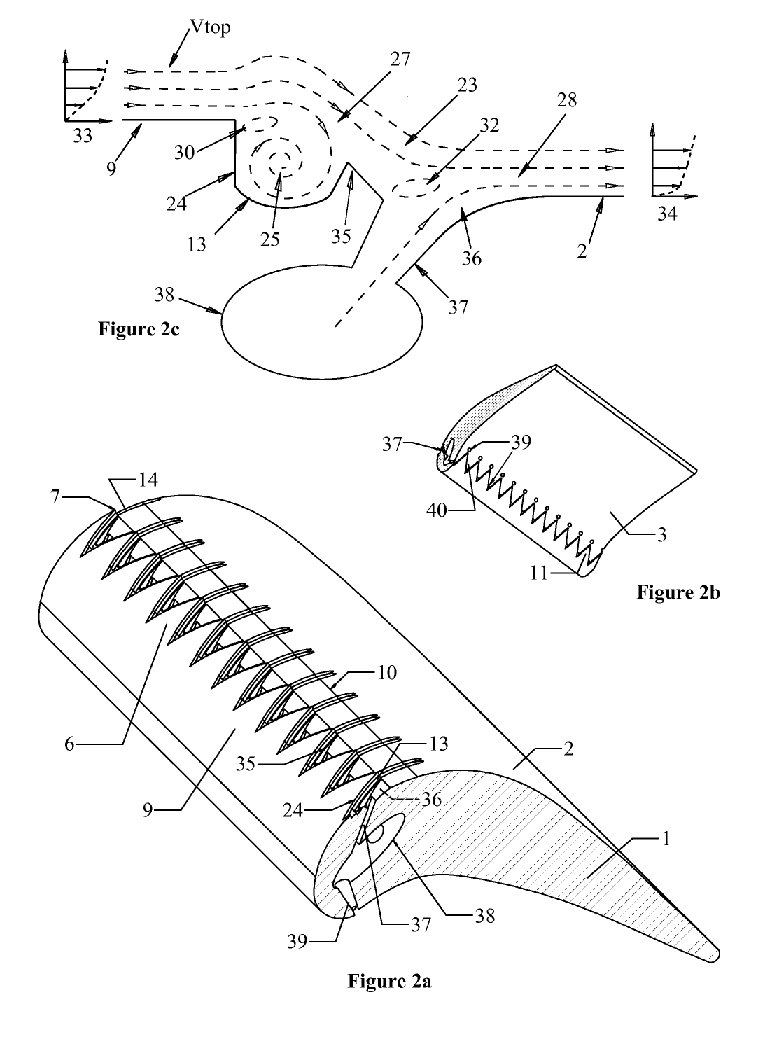

The integrated upper CVG valley point 8 is positioned chordwise so the incoming fluid-flow at the suction-face flow entry, 9, intercepts and experiences a pair of diverging angled aft-facing step edges 24 of FIG. 2a. This high velocity flow is still parallel or tangential to the entering blade surface or foil design-intent at suction-face flow entry 9, and experiences a flow separation (step shear separation region 27 of cross-section FIG. 2c), in the lower fluid-flow layers all along and behind the intercepting top edge of the steps, since the flow cannot make the sharp turn downwards to follow the step top edge contour.

This intentionally angled step-down flow separation mechanism begins to roll-up part of the separated lower energy and bottom-most BL incoming fluid-flow mass into a bound and free-flowing step-vortex, item 25 of FIG. 2c, that extends and flows along the step bottom edge and back towards the upper CVG tips, 7. This step-vortex comprised of the sheared or sliced-off lowest-energy lower incoming fluid momentum layers then meets and balances against the opposite rotating-sense vortex from the other side of the tip, and then they stream backwards in counter-rotating vortex-pair filaments tightly bound to the surface along the blade chord. The incoming un-sheared flow momentum layer and above that does not quite get rolled into the step vortices continues rearward as exit high energy flow, 23, over and past the top of the step-vortex structures, and then with an initial downward velocity component, reattaches downstream to the surface at the step exit-streamline reattachment location, 28 (FIG. 2) as a now higher energy and thinner BL with reduced; transitional turbulence, hairpin-vortex structures and drag losses in the this downstream BL area between the CVG tips. Thus the CVG step geometry acts as a “BL-slicer” to create beneficial vortices, but also provides a controllable BL re-laminarization effect downstream of the bulk of the step width between tips, to reduce drag over an unmodified surface, particularly at zero and low positive and negative AoA's.

This is an additional drag reduction mechanism that conventional VG's do not exhibit, since they are known increase drag at zero, and low positive and negative AoA values, where VG AoA extension capability is not active. The entry BL flow velocity vector diagram 33 shows the normal BL gradient from low surface velocity, increasing higher into the BL. Downstream of the step, exit BL flow velocity vector diagram 34 shows that these lower BL layers have a greater velocity and improved attachment capability over that of the lowest entry layers stripped into the step-vortex and then ejected via the CVG tip vortex-pairs. The notional top of the BL or freestream velocity is indicated as the streamline, Vtop.

The CVG step-vortex 25 flows rearwards in a continuous predictable and controlled manner along an optimal mass-accumulation length and angle, and is unlike the trapped chaotic vortex of e.g. a long spanwise aft-facing step. The CVG tip primary tip-vortex pairs are very intense and geometrically stable and efficiently harvest flow energy and fluid mass and momentum from the whole shear flow regions of the flow sheets that intercept or cross the CVG steps along the embodiment width. The CVG tip-vortex pair filaments also act as conventional VG's do at high AoA, in that they affect the surrounding downstream BL and can break up any forming fluid-flow detachment bubbles and structures, and this allows the blade stall-AoA to be extended significantly by about +5 degrees, depending on foil design. Adjacent areas of the BL are affected by the passage of the energetic CVG tip-vortex filaments and the extra fluid-flow energy also tends to suppress hairpin vortices and thickening of this nearby BL area. Thus CVG's extend the AoA or local fluid-flow surface control range that may be processed with energy loss reduced from baseline surface configuration.

Note that up to the point of separation this new art blade surface design has its “normal or ideal” geometric surface design that ensures efficient entry of fluid-flow, so does not induce any upstream added drag or horseshoe vortices before the steps. Ramp style, Wheeler or blade type VG's trying to generate vortices at this location have to diverge from the correct or ideal blade shape and inefficiently intrude a distance into the higher BL flow, creating drag. Since integrated CVG elements or arrays effectively define the new-design baseline desired LE entry surface or foil geometry design as equal to the ideal foil design, behind the step the aft surface design now is effectively stepped into the surface by this new integrated CVG design intent. In this way a new design foil or surface remains setup for correct fluid-flows at the critical laminar flow LE sections, as for the original foil design, so the aft sections are now shrunk inwards by the step offset. For additive CVG's on foil or surface designs not configured or adjusted for CVG addition, the LE entry section is effectively thickened and disrupted by e.g. twice the additive CVG array film/step thickness in the application area.

Conformal Vortex Generators are unique in that they work on and process the very lowest boundary layers crossing the aft-facing steps (of any height) and generate chordwise persistent primary tip-vortex filaments that are closely bound at their central chordwise low-pressure mutual stagnation line to remain in close contact with the downstream blade surfaces, even in the face of extremely high centripetal accelerations and secondary flows above the BL levels.

Flow visualizations teach that on a helicopter rotor blade at 1,200 gravity radial tip accelerations and 700 fps velocities that the CVG tip vortex-pair stagnation lines trap surface dust, and effectively “fence” this and lowest BL flows in, to remain chordwise on the blade, in the face of strong radial forces and other secondary airflows, that will completely remove the dust from blades not using this new art CVG technology. This strong step and chordwise vortex flow distribution explains how the CVG's can efficiently entrain energy from the higher incoming fluid-flow momentum layers and spread this chordwise and spanwise and help control any aft regions (i.e. towards the trailing edge, 5) that try to form a flow separation bubble and detach. The primary CVG tip-vortex pairs and step-vortices have a number of associated secondary vortices and eddies that tend to progressively equalize pressures and momentum, so the flow shears are minimized at, and aft of, the CVG structures and steps.

Along the CVG steps, dust accumulations teach that the step faces and bases are also stagnation regions, and that once the fraction of lowest level and lower momentum BL flow has been separated into feeding the primary tip-vortex pairs, the remaining higher up, higher energy and higher momentum layers then can find an efficient flow path slightly downwards to re-attach as the new more energetic downstream BL trapped between the CVG tips. Note that the primary CVG vortex pairs can be made small and of the geometric size range of the step and BL thickness, and are not normally exposed to free stream or secondary flows above the top of the notional BL. This allows the CVG vortices the possibility of being fully submerged in the lowest levels of the BL, and be at least an order of magnitude more persistent and effective in the downstream direction geometry than reported by e.g. NASA, for vortices generated by other mechanisms. Between the CVG elements in an array there are no entry flow loss-generating horseshoe vortices.

Most other VG structures have high drag (e.g. protruding ramp types), are structurally delicate (vane type), are limited by geometry to a limited range of workable Re flow regimes, do not produce persistent and submerged vortices or produce lower energy vortices (e.g. dimples) or vortices subject to secondary flows and effects. Prior art active flow control devices on blades such as; angled jets and synthetic flow jets can reenergize the boundary layer to reduce flow separation, but induce energy loss horseshoe or kidney vortices and only influence flows in a limited range about fixed points and are generally more complex, and do not exhibit significant drag reductions over baseline unmodified geometry.

Reenergizing the BL regions aft of the CVG's allows the blade to extend its un-stalled (low drag) angle of attack, AoA, by about +5 degrees, before separation bubbles finally form and drag increases, while lift reduces. This improved AoA extension of the A-curve has occurred on different tested foils, teaching that the fluid-flow physics scale well across blade geometries and Re numbers. This improvement for LPT blades allows the design turning-angle of a new blade cascade design to be increased (increasing the Zwiefel coefficient) for more compact, fewer stage turbine and/or compressor cascade designs, or can simply be used to allow greater operation latitude for new cascades operating off-design, or a preferred combination of these possibilities.

A further valuable feature of this new CVG art is that the blade drag compared to baseline is significantly reduced by about −5% to −10% at the same lift and AoA, from zero incidence to closer to the stall angle. This is attributed to the fact that the reenergized suction-face BL also has higher velocity and is thinned and hence generates less turbulent-fluid losses while generating lift. The CVG array vortices and BL energization are passive and are generated in a very efficient manner and do not adversely affect the designed blade drag performance, but enhance it by reducing it across the fluid-flow range.

For an integrated lower CVG array, 11, an example of a lower CVG valley is shown at 12, and this also steps inwards into the blade foil profile to form an angled aft-facing step in the same manner as the upper CVG array, 6. The pressure-face has a different chordwise pressure and velocity profile, but the lower CVG valley 12 is configured in a similar manner as for the upper CVG valley 8, an instance in the upper CVG array, 6.

Testing on foils teaches that some of the blade drag improvement comes from also including the lower CVG array, 11, that improves the flow on the foil pressure-face and disrupts the formation of e.g. TG vortices from stresses due to concave centripetal flows. Lower CVG array, 11 also acts to thin the downstream pressure-face BL layer which reduces turbulence and drag.

It is possible to design the blade to operate with either, or both CVG arrays, but the suction-face CVG array addresses one of the primary prior art acknowledged problems of LPT blade suction-face flow separation.

In a cascade a shock wave from e.g. the suction-face pressure recovery flow can form and disturb the blade passage flows, particularly if the blade TE structural thickness induces blade-passage flow-choking and resultant shock waves at certain fluid-flows. Intentional CVG vortex flows impinging on Shock Boundary Layer Interactions (SBLI) at the lambda-foot shock wave separations can be used to mitigate shocks and energy losses on foils, fluid-flow control surfaces and ducts.

Configuration and design of effective CVG's is aided by the fact that they work well over a broad range of geometries, and can be readily adjusted to meet specific requirements. Testing shows that as CVG geometries are modified the results are generally within a smooth range of changes, without rapid fluctuations or singularity points, that is, they are well behaved across a large range of design conditions. Since CVG's always start at the bottom of the BL, they do not intrude outside the BL at any practical Re values.

Vorticity starts at Re numbers of about 300 in standard atmosphere, and is of sufficient energy at about 30,000 to be beneficial. From about Re 30,000 to 500,000+ where LPT blades can operate, the CVG's may be configured to provide improvements. From an Re of 500,000 to e.g. 10+ 770 million, CVGs can be very effective on isolated foil and body sections and fluid dynamics structures, including rotating components. Note that CVG steps can be a small fraction of the BL height at the operating location and still generate very strong and beneficial fluid-flow control capabilities, but in the more general case and at varied Re operating points, may also be usefully employed as a greater fraction or even multiples of the local BL thickness.

A conformal vortex generator or CVG can be broadly described as a fluid-flow modifying element designed with; (a) a low-loss entry configuration that matches the entry surface-flow streamlines, (b) an intercepting flow-angled aft-facing step to induce the incoming fluid-flow lowest levels to shear into a step-vortex which communicates this sheared flow along an output surface, to (c) an exit point to remove the accumulated step-vortex sheared flow, and (d) allowing the balance of incoming higher energy un-sheared layers to reestablish as a new downstream boundary layer with higher energy.

The CVG flow-angled steps are typically configured at about a twenty-two degree angle (for air as the working Newtonian fluid) spanwise with respect to the local input flow streamline vector, but will operate around this approximate nominal value with some performance shifts, and this exact angle depends on the working fluid conditions. So it is possible to adjust any of the CVG step angles to be optimized for different local flow directions, such as being integrated into flows at the hub and tip end-walls and the like.

CVG steps are typically paired at the rear tips into chevron or triangle-like structures with tips facing rearwards that then produce persistent and stable exit tip-vortex pairs, and can be combined into variable offset arrays of a number of adjacent CVG step edge structures with varying angles, step geometries and step heights and step lengths to allow for variations in input flow vectors and conditions. The CVG design geometry allows precise control of fluid-flows at different points over a surface area configured with them. CVG's are configured for a given surface geometry, at a characteristic; step height, length and angle, and for an e.g. 50 mm wide LPT blade chord may be chosen at about an e.g; 22 degree local angle fluid-flow intercept, triangular form, 3 mm step length, 100 um (micro-meter) step height and located around the high-velocity laminar flow transition regions, for expected Re values and typical blade foil section. These geometry start-point values may be readily modified and then confirmed as optimal, by a series of actual blade step testing and performance measurements, but are not practical for additive CVG's in this LPT environment, due to small size and operating stresses. The CVG step height is adjustable over a wide range and is configured to generate sufficient vorticity along the step edges for the designed operating range of Re values, while rejecting a sensible level of the incoming lower BL flow into the primary chordwise vortices. This CVG design process can also be employed beneficially on a fixed stator blade array to lower drag and increase turning-angle capability before off-design separation at varying Re's is a problem.

A spanwise step along a foil surface, at right angles or 90 degrees to flow, typically traps a chaotic spanwise step vortex and is known to increase drag about +5% over the baseline unmodified blade, and the best case is now when this step is broken up into e.g. CVG segments that are at about a 22 degree angle to the flow, with about a −10% drag reduction, but these numbers are not limiting. Interestingly, tests show a worst case drag greater than the 90 degree (linear aft facing step edge) case, when the CVG step is at about 60 degrees to flow, where the step accumulation length is long. This shows that at some point the step vortices are overdriven with accumulated low-energy fluid mass at the step-vortex size and flow capacity, and start to expand to become an impediment to the incoming flow streamlines, and so the CVG mechanism becomes adverse to drag, worse than a linear spanwise aft facing step. Although lowering drag is a key design goal, having the ability to create a controlled amount of both drag increase and reduction allows CVG's to be employed as a novel fluid-flow modification tool in many precise ways.

The mechanical and fabrication sharpness and definition of the CVG structures is not particularly critical, but the ‘sharper’ (minimum radius) the step top-edge is, the better the entry flows will separate stably and predictably with minimal secondary eddies. The CVG valley may also be simply configured with a radius and the CVG tips may be either sharp or also configured with a radius or other geometry, with minimal performance sensitivity. The bottom transition of the step to the output surface is at a stagnation point, with other secondary stress vortices, so may be set at a convenient radius fillet that does not interfere with the step's top-edge shearing function.

For a cast, forged, fabricated or machined part formed in any combination of processing, materials or manufacturing manners it is of benefit to radius the step bottom edges to alleviate stress for both fabrication and minimizing stress focusing of vibrational and flexure modes when operating. The step top edge is typically clear of the body iso-strain and deflection lines.

In high acceleration and/or vibration environments the positioning of CVG's may be optimized in that they are configured spatially on same and opposite surfaces to avoid tuned vibrational modes and coherent reflection points and structures. So a regular array on a face may be optimized by adjusting individual CVG element; tip and valley positions ; CVG step lengths (effectively defining pitch) and angles in a non-uniform manner so as detune the blade vibration response, and not to enhance unwanted blade flexing and coupled excited vibration and mechanical resonance modes. This can also be performed with reference to both blade faces, so as to ensure that blade strains are not focused coherently between suction and pressure positions and cause increased fatigue issues.

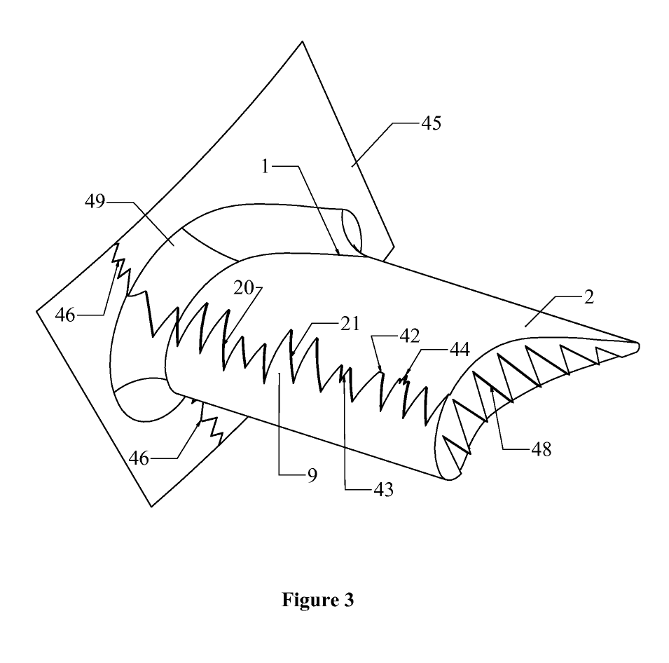

Item 21 in FIG. 3 shows an asymmetric suction-face CVG ‘V-form’ instance with the left-side angle that is more acute than the right-side angle, so as to make this CVG non-symmetric and able to process the BL flows on each side of the tip in a slightly different manner. The BL mass flow over the left-side is effectively narrower, so the step-stripped BL mass flowing into the left side tip-vortex is less, with a resulting smaller and less powerful left side tip-vortex. On the right side of this CVG the wider interception of the incoming flow means that the right side tip-vortex is correspondingly bigger and more powerful. The balance of forces and vorticity vectors and magnitude between these two asymmetric counter-rotating tip vortices are now modified, so they stream more to the left on the suction face, and as they dissipate into the wake after the TE there is a residual more-clockwise vorticity magnitude balance and this matches the normal effective blade vortex lift sum clockwise direction “or polarity” as shown in FIG. 3, assuming the blade inboard or root end is at the location of the item 1 shown in FIG. 3. Depending on the final configurations of residual vorticity it is possible to affect upwards or downwards the body lift coefficient, C_{L}. For this configuration, if a pressure-face CVG is modified in the opposite direction (i.e. the CVG left side is wider, as viewed through the top) this will also add positively to the effective induced-circulation lift-vorticity sum into the wake, and raise C_{L}. Note that the drag reduction due to CVG BL re-laminarization is modified by small vortex location shifts but still is effective between the CVG tips, since essentially the same re-energized mass flows occur per unit width of the BL entry width. The passages of the modified tip-vortex pairs affect the streaming vorticity generated in the immediately adjacent thickening BL areas so modify the lift vorticity summed from these regions.

FIG. 1c, shows a close-up detail of a collection of CVG items. The triangle shown with vertices A-B-C is one V-form CVG instance, and will operate as a single instance to slice the incoming BL from width A-B and move the sheared lower BL fluid mass rearward along both steps A-C and B-C and eject this with twin vortices streaming back from tip, C. If CVG's are employed as an add-on instance on e.g. a helicopter LE EPS system, then the smallest sensible CVG element would be a CVG section of width A-B and include the suction and pressure-face CVG's attached continuously around the LE section, and can be employed then as a combined array of many of these basic CVG structures. For simplicity CVG's are typically fabricated in arrays of many combined CVG tip sections that can be mounted adjacently on a fluid dynamics body to modify flows. Small practical gaps between mounted CVG elements have minimal effects compared to the CVG efficacy and performance improvements. Additionally, these larger CVG arrays are configured to be convenient to handle and apply and incorporate alignment features and layers that will indicate wear as they abrade in the fluid-flows.

FIG. 1a depicts the individual CVG elements as essentially triangular, but this example is simply for ease of display, and in fact the best performance is with an essentially ogival form of step edges, such as used for NACA low-loss submerged inlets. These NACA inlets also produce edge vortices to decelerate the inlet flows, but have a subtly different geometry and are not deployed in arrays to reduce form drag or re-energize the BL, and have step heights many times the local BL depth, so are very unlike the new integrated CVG art, except that vortices and optimized flow dynamics geometries are used.

The Ogival CVG form departs from the triangular-form step-lines when approaching the tips by typically following a slightly upstream location and more acute angle compared to the triangular step-line. This expands the available upstream surface extent of the accumulating step-vortex bound by this location-defining aft-facing step. The incoming stripped fluid-flow mass accumulates along the whole angled step, so the aft sections include a greater mass and tend to increase vortex size and velocity, and tend to grow more into the incoming fluid-flows. If the step vortex grows too large from sheared fluid mass then at those locations it will tend to impinge upon the overtopping un-sheared step-flows, which subject this primary step-vortex structure 25 to greater disruption and will tend to elongate the outer step-vortex layers, or adversely break up the step vortex into several components. Step-vortex 25 in the FIG. 2c section view shows a slight upwards extension to highlight the effect of this vortex location exceeding the step height and geometry.

This means that in some embodiments it is beneficial to optionally provide a shaped step-vortex expansion groove 13 at an optimal location below any of the step-vortex paths to accommodate the expansion of the step-vortex by fluid-mass accumulation. This avoids excess impingement outwards of the growing step-vortex diameter as an impediment and energy loss to the un-sheared overtopping-flows that re-attach as the new BL downstream, for a given step height. At the CVG tips these expansion grooves (or any shaped trenches) may merge or parallel from opposing steps and be extended an amount aft as tip-vortex expansion groove 14 and provide a guide for the streaming tip-vortex pairs, so as to lessen distortion in the higher fluid-flows. This vortex expansion improvement allows a given step height to strip a greater mass of incoming fluid-flows, allowing a more intense downstream BL re-energization and tip-vortices. For a foil or aero/hydrodynamic surface consideration is made of the structural impacts of these material removals, but in many cases the fabrication of 3D surface structures in e.g. a forging may improve section inertial cross-section, rigidity and surface mechanical properties. Step-vortex 25 has a number of secondary flow structures and eddies such as the upper step eddy structure 30 and the step shear-equalizing eddies 32 that act to balance inertial and shear forces.

Adding an optional step shear guide 35 section as a optimally shaped and built-up ridge allows further suppression of step shear-equalizing eddies 32 and lower flow losses from eddies or secondary vortices, and help to define a spatial cutoff edge for the rearward expansion of step-vortex 25 with varying Re conditions.

In additive CVG embodiments a replaceable additive CVG EPS material, such as; elastomeric, plastic, resin, metal, metal film, ceramic-coated substrate, carbon fiber, carbon-carbon, silicon-carbide or metal fiber matrix or ceramic matrix composite (CMC) or other material combination is applied on a composite or FRP material or metal helicopter rotor blade, or wing LE etc., and expansion groove 13 and 14 may be molded or integrated into the foil or body surface at any of the e.g. suction or pressure CVG steps, along with CVG registration marks and steps of partial heights. An additive CVG EPS film can then be added in mechanical register over these integrated CVG features to create the combined step features and CVG functionality. An FRP (composite) surface or an e.g. metal rotor blade or wing/fixed foil LE may have these new features integrated by any fabrication means into the LE, but in this case since erosion and paint damage from dust and rain etc., is a significant problem, combinations of integrated CVG's with add-on and field-replaceable additive CVG's are better to protect the LE surfaces to maintain energy efficient laminar or low turbulence flow.

CVG's cascaded at close aerodynamic spacing may not typically provide best combined benefit due to vortex interaction. Unless properly separated, particularly on a rotating surface, vorticies and flows need to be tightly spatially controlled so as not to interfere, or be separated in the flow direction, so as to minimize disturbances. Wake interactions from upstream stators, rotors and other transient disturbances are not so problematic for performance, since they are much larger structures than the CVG tip vortices and typically outside the BL, and flows can be spread across several small CVG elements which can “harvest” or swallow this vortex, rotational or impulsive fluid energy, since they can operate effectively over extreme Re values. Measured cyclic vibration and NP rms strain reduction on helicopter blades of about 30% throughout the flight envelope teach that CVG's can operate very effectively through large cyclic flow extremes of AoA's and flow perturbations.

Note that a controlled amount of lower BL layer fluid mass is effectively stripped from the entry surface flow (and rejected in the CVG tip-vortex pairs), and this is effectively the goal of active suction BL control systems using porous aerodynamic surfaces or suction stripper step edges or slots. Many prior art active systems were abandoned due to clogging problems, so CVG's employed at this location for BL control are superior, with the addition of the CVG tip vortices to extend surface control effectiveness, and also lower drag. This has been shown by employing additive CVG's on the LE of deep-chord foils like the wing ahead of the ailerons of a Piper PA-Navajo that improve control authority of the ailerons at wing stall, lower aircraft stall speed and increase cruise speed. This would be an example of a non-rotating fluid-flow environment, like the LPT/Fan/LPC stator, whereas a Helicopter rotor or a propeller/prop-rotor is a rotating fluid-flow control example, like a LPT/Fan/LPC rotor blade, but with different solidity, aspect ratio etc., using CVG's with about 20 mm step lengths and 300-500 um step heights for foil chords of about 180 mm, but these values are not limiting and depend on Re and geometry.

Another integrated flow control method in combination with integrated CVGs that can be additionally employed on LPT rotor and stator blades is to employ fluid-flow jets to inject or add fluid-flow and BL momentum at or after the CVG steps. These jets can be active from a fluid pressure source as in prior art synthetic jets, or can be foil pressure-face fluid harvested around the higher pressure or lower face CVG array 11 after being suitably conducted up via an array of paths, passages and plenums to the suction side surface.

The FIG. 2c cross section shows an aft angled jet fluid injection port 37 and/or metering orifice that can convey fluid-flows of suitable pressure and flow rate from an injection plenum 38 up to an output surface such as 2. The addition of a low drag fluid-flow injection cavity 36 at the surface behind the aft facing step edges 24, and located between the CVG tips is optional and improves fluid-flow performance. Adding a fluid jet in this aft angled manner (optionally exiting into a shaped cavity) takes advantage of part of the downward velocity vector of the exit high energy flow 23 to suppress jet-liftoff at high blowing and flow momentum-ratios and helps to spread the jet fluid stream laterally and in the flow direction. The contoured shape and diverging exit fluid-flow of fluid-flow injection cavity 36 allows the added energy of the jet injection fluid to be placed at the lowest BL locations close to the surface to aid in further BL reenergization capability (like the prior art Coanda effect or slot blowing techniques), and best performance is when there is minimum velocity differential/shear and turbulence into the merging exit high energy flow 23. The advantage of combining a CVG with an injection jet or suction port is that this inherently drag reducing CVG structure is efficiently employed with flow augmentation, to further improve fluid-flow performance.

Since the aft angled jet fluid injection port 37 is below the exit high energy flow 23 the dynamic pressure here is lower than that of a stagnant BL at lowest levels, so the designed jet mass fluid-flow volume can be effectively provided with lower pressures in injection plenum 38. A lower pressure flow and greater volume capacity due to effects of the downward exit high energy flow 23 allows for a larger size of jet fluid injection port 37, which is then less subject to the risk of being clogged with debris. It is also possible and optional to use a number of instances of jet fluid injection port 37 arranged to feed onto the surface, or into one or more instance of fluid-flow injection cavity 36, between CVG tips so that there is greater fluid-flow spreading laterally and other alternate and redundant jet orifices still available and active if some become clogged.

This jet flow enhancement uses additional fluid-flow energy and can be employed to assist controlling BL separation and drag, and injection plenum 38 can be fed by pressure-face fluid transmittal port 39 located in low-drag fluid pickup point 40, optimally close to the high pressure stagnation points in pressure-face CVG valley 12, or filtered compressor bleed or auxiliary air sources or even the net-zero mass-flow methods like a pulsating acoustic pressure source.

Employing low-drag fluid pickup point 40 as a fluid source of suitable pressure is an example of beneficially coupling the surfaces of different parts of a 3D fluid-flow structure, and the port and plenum sizes are configured to provide the correct metered fluid-flows in relation to the pressure differentials. If the additional fluid-flow energy for the jets is derived from a fluid source that varies in pressure in sympathy with the surface or engine flow and velocity conditions at varying off-design and Re values, then the jet fluid momentum will generally track across the varying Re conditions without needing any optional flow or pressure regulation to avoid jet-liftoff, that can occur if a fixed or non-varying pressure fluid-flow source is employed to energize the jets. This pressure face fluid harvesting effectively acts as active suction BL control on the pressure face.

On a rotating foil or body surface the instances of jet fluid injection port 37 can be connected into instances of injection plenum 38 with a shrouded or setback entry port that configured to be pointed slightly outboard at the plenum initiation point, so as to generally reject heavier dust and debris flowing outboard in the plenums, and not capable of making a large angle or path deviation turn and enter and clog the jets. This inertially separated dust and debris travels generally outboard in a centripetal environment (or due to flow pressure/momentum in the stator foil case) and then is optionally ejected out a suitable plenum rejection tip orifice 41 closer to the TE. The plenum rejection tip orifice 41 may be larger and employ centripetal acceleration forces to control a self-cleaning process by; partially blocking the discharge orifice at full operating speed (without wasting excess fluid-flows) and as the rotor blade slows down to idle a simple force-controlled mechanism can then open this self-cleaning port to maximum and allow the dumping of excess large particle buildups while there is still a flushing fluid-flow through the turbine stages.

The low-drag local source of pressure fluid taken via fluid transmittal port 39 from a low-drag fluid pickup point 40 around the pressure-face lower CVG array 11 is configured to reject the high momentum and energy debris or dust etc. moving past in the higher BL flows.

An alternate pressure-face configuration for jet-blowing (versus jet fluid-supply or BL suction) may be created by configuring pressure-face fluid pickups 39 located in the low-drag fluid pickup point 40 in the reverse direction as a version of jet fluid injection port 37, fed by a second instance of a pressurized injection plenum 38, separated from the plenum instance feeding the suction-face jets. This allows a separate configured jet fluid pressure source from e.g. filtered compressor bleed air to augment the pressure-face BL separation capability.

These pressure-fed blown-jet methods additionally improve downstream BL momentum for both suction and pressure surfaces and a further alternative is to couple the fluid-flow injection cavity 36, injection plenum 38, etc. to a fluid suction source to withdraw additional lower-energy fluid mass from between the CVG tips to then provide a downstream BL with increased momentum.

Slots or other 3D shaped flow conduction structures may be chosen instead of e.g. round holes for jet fluid injection port 37 and the method chosen takes account of the fabrication difficulty and mechanical integrity of the foil or blade. Injection plenum 38 can be fabricated in several separated spanwise sections feeding separate CVG areas to ensure the centripetally induced pressure gradients do not starve the inner CVG fluid-flow injection cavity 36 areas or overdrive the more outboard CVG fluid-flow injection cavity 36 areas. Jet fluid injection port 37 sizes may be varied along the blade span to also meter out and even out the fluid injection flows due to pressure gradients. The material mass-removal closer to the body or foil center line to hollow out and fabricate the injection plenum 38 instance(s) does not greatly reduce section inertia or bending strength but does lower blade, turbine and engine weight.

FIG. 3 shows an LPT blade connected at root 1 to a turbine hub wall 45 with a wall fillet 49 and shows other possible combined variations of CVG embodiments. Item 20 shows longer CVG v-sections in an array. Item 42 depicts a CVG tip that has been clipped back in the spanwise direction, so as to widen the separation of the tip-vortex pairs. This also includes a larger amount of the included tip width BL able to flow and mix directly into the tip-vortex pairs and be wrapped up into the tip vortices and intensify these.

Item 43 shows a CVG tip modified to also create two wider spaced counter-rotating vortex pairs. In this variation a further set of acute-angled smaller and inside included CVG steps generate smaller counter-rotating tip vortices bound against the larger outside tip vortices. This widens the area affected and processed by the now two primary and two secondary streaming tip vortices.

Item 44 shows a further tip variation that creates two primary tip vortices partway down the CVG step and then a smaller tip width at the CVG vertex with two smaller secondary tip vortices.

In all these cases the subtended width of the CVG steps in the spanwise direction precisely controls the mass flow into each of the vortex structures allowing controllable flow effects. CVG structures and arrays may be employed around the circumference of the LPT cascade 3D blade passages and entry surfaces like wall CVG array 46 to improve rotor or stator drag and flows. In a rotating rotor blade environment a serial instances of CVG's are adverse to drag performance due to vortex interference in angled secondary flows, but may be used on the stator in a multiply cascaded form with optimum spacing and offsets, or in some cases for other purposes such as secondary flow separation modifications.

A symmetric or asymmetric second array CVG 47 (step-down into body) at the trailing edge 5, may be employed on either suction and/or pressure-face to modify blade wakes and improve lift/vorticity since they are wholly and immediately on the surface before the TE exit flows. In the rotor case these are less adversely affected in the rotating environment than CVG's employed as e.g. a second row closer to the upper CVG array 6, or 11.

The blade root platforms and constant radius type and 3D ducting flow surfaces and fillets at the root-ends of the blade passages and the possible tip connection end-walls can also benefit from CVG drag reducing BL re-laminarization and also reduction of flow separations induced by secondary flows like the blade passage vortex etc.

LPT ‘squealer’ tip ends or outside tip shroud surfaces are often abrasive and expand with the intense operational heat changes and are designed to occasionally contact and abrasively clear the tip paths against the close-clearance tip-seal shrouds and duct surfaces. In the resulting tip-gaps at temperature there are large pressure differentials and secondary tip flows, and the surface of the tip-seal shrouds has a BL and secondary flows that are swept by at high relative fluid-flow tip speeds.

The end of the LPT ‘squealer’ tip ends or outside tip shroud surfaces may employ an integrated tip-end CVG array 48, with the tips pointed downstream in the local relative fluid-flow direction, and this allows removal and ejection of nearby low-energy shroud BL and re-energization to lower losses and drag on both the shroud and tip structure . The tip-vortices of tip-end CVG array 48 stream into the pressure-face side of the blade-tip pressure-differential, and the step-vortex sits across the tip end-flows, so as to disrupt the blade's tip-vortex organizing as a more coherent and powerful flow structure.

Turbine stage blades, surfaces and ducts also have large wetted-surface areas in the fluid-flows with thickening BL flows on the suction and pressure fluid-flow faces, so the integrated CVG BL re-laminarization operates to lower form drag and fluid-flow losses and reduce wake momentum deficits. The intensity, surface attachment and velocities of the CVG tip-vortices allow a new mechanism that allows a continuous and rapid re-establishment of attached flows after periodic upstream wake disturbances. This is also similarly the case for any other flow sections such as compressor stages, combustors, ducts etc.

The LPT turbine blade design methods taught here can be employed to optimize new turbine designs and configurations of; rotors, stators and duct passages with; lower drag and fluid-flow and energy losses, improved flow reliability, greater operational latitude for off-design conditions, lower solidity and greater turning-angle per stage.

Alternatively, these new art blades can be configured with lower drag losses and applied as “plug compatible” upgrade elements matching interface geometry and flow angles into an existing turbine stage at a service update interval to provide improved engine drag performance and lower energy losses within the existing long life engine investment. Thus while new integrated CVG type LPT designs can take advantage of this new CVG art, it is also possible to make “plug-compatible” LPT blades that install and function correctly and replace old-art blades within an existing LPT stage cascade, such as an e.g. CFM-56 turbofan engine, to improve both low Re flow separation margins and to lower drag, to improve SFC of an existing engine investment. The LPT rotor and stator blade are one of the lowest risk modification areas in a turbofan engine.

Alternatively, these CVG array embodiments and art may be employed in other similar fluid-flow areas such as, e.g. wind turbine blades (like Godsk '259), or a propeller, where stall AoA and operating envelope may be increased without a drag increase, and in fact blade and surface energy losses may be reduced. Even though the foil design, aspect ratio and solidity etc., are different to these cited LPT cascade embodiments, integrated CVG's can be configured into these fluid-flow control surfaces as well.

Axial Compressor: Axial compressor stages are typically designed with much thinner and finer-edged high speed transonic foil bodies (not reaction-bucket styles) to allow maximum compression efficiency and momentum transfer into the fluid-flows in each stage. These foil or blade sections can benefit from integrated CVG application in the same general manner as shown for the LPT turbine foils. Extending axial compressor rotor and stator stall AoA capability at the on-design turning-angles improves compressor surge (and surface stall and separation) margins to flow disturbances causing massive cascading flow separations in following stages. LPT or other turbine stages do not tend to suffer as badly from this cascading separation failure or surge mechanism of axial compressors.

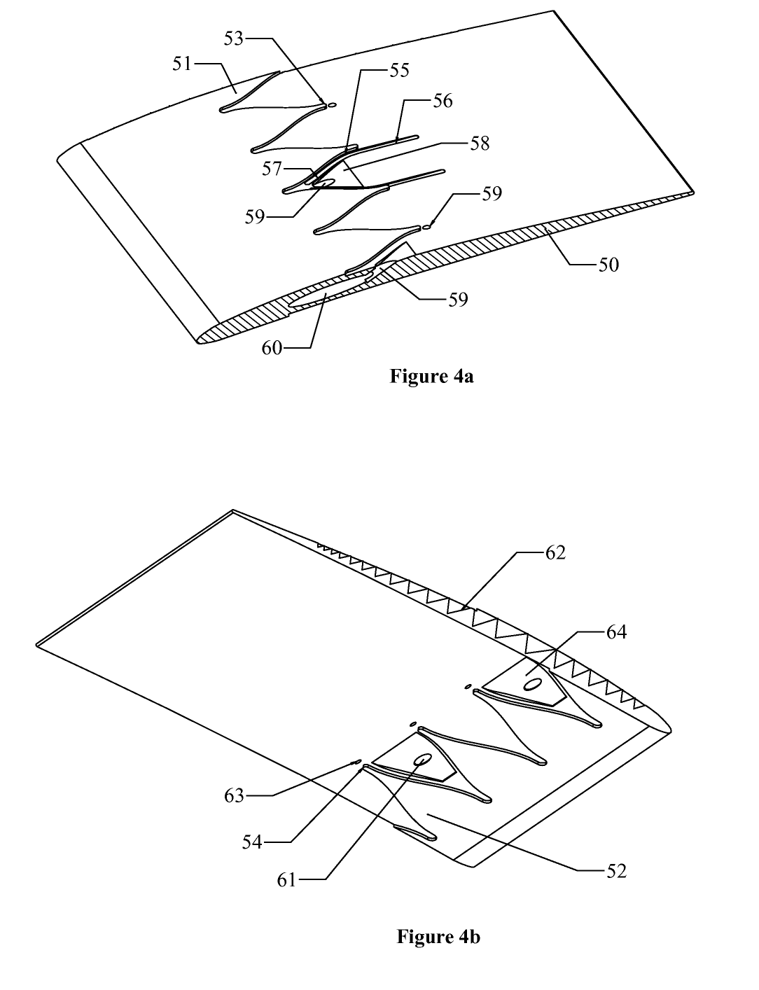

FIG. 4 depicts a stylized example of an isolated axial compressor blade body, 50. The compressor low-pressure compressor (LPC), mid- pressure compressor (MPC) and high-pressure compressor (HPC) pressure stages may have varying blade lengths, changing root and tip diameters (or “compressor lines”) depending on disc area, local flow and pressure requirements. Rotor and stator foils employ slightly different geometry, since the stators act as diffusers for recovering stage pressure, but CVG's can be employed in a similar manner to all these fluid-flow control surfaces and gain similar benefits as taught for LPT stages.

The axial compressor embedded suction CVG array 51 is integrated or fabricated inherently onto the forward part of the foil suction face, and this structure is designed to convert a fraction of the incoming free-stream flow energy at the input turning-angle into a pair of intense counter-rotating CVG tip vortices that stream backward from the array of axial compressor suction CVG tips 53, and that can provide suction-face separation control similar to conventional VG's, which cannot be employed as low drag or drag-reducing in this rotating body fluid-flow environment. Similarly an axial compressor embedded pressure CVG array 52 is integrated or fabricated onto the forward part of the foil pressure face, and this structure is designed to convert a fraction of the incoming free-stream fluid-flow energy at the input turning-angle into a pair of intense counter-rotating CVG tip vortices that stream backward from the array of axial compressor pressure CVG tips 54.

The integrated CVG form versions shown here in FIG. 4 are generally a repeating pattern of symmetric ogival-edged triangular forms, and can these be configured and varied in the same manner as previously taught for LPT surface treatments and embodiments of steps and gross CVG geometries across the span and into the end-walls and fillets of the blade passages. Optional step-vortex expansion grooves 55 and tip-vortex expansion grooves 56 and step shear guide 57 may be integrated into both faces to improve step vortex capacity, as taught for the LPT stages.

Surge or flow separation margins are improved by the addition of integrated CVG's fundamentally extending the foil stalling AoA capability, with the fluid-flow improvements detailed as for the LPT stages, along with extending laminar flow performance and drag reductions. Further compressor improvements are possible by employing the unique capability of CVG's to provide a low-drag fluid-flow injection capability into the lowest levels of BL, particularly in the later suction-face areas subject to adverse pressure gradient flow velocity reduction and flow separation bubbles.

For simplicity just one complete instance of optional fluid injection cavity 58 is shown integrated and configured optimally between CVG tips, and this is fed with suitable energizing fluid-flows from a 3D-angled jet fluid injection port 59 at a defined pressure and mass-flow rate to add more flow energization of the downstream BL. This takes advantage of the initial downward-vector of the exit high energy flow over the CVG steps to avoid jet-liftoff and minimize any LE horseshoe or kidney vortices at high blowing and flow momentum-ratios and helps to spread the jet fluid stream laterally and in the flow direction. Multiple instances of fluid injection cavity 58 and jet fluid injection port 59 may be distributed across the foil suction surface and connected to a pressurized supply of injection fluid in instances of injection plenum 60. Fluid transmittal port 61 and low drag fluid collection feature 64 may be connected to injection plenum 60, and/or tip collection port 63 to provide a local jet fluid source. The jets and plenum fluid-flow augmentation capabilities are configured in the same manner as the LPT stages. The entry of fluid from another source is possible with instances of injection plenum 60 connected at root or tips to an alternate jet fluid source, such as e.g. later stage compressor bleed air that may also be optionally pre-cooled to increase fluid density.

A tip-end CVG array 62, equivalent of the integrated tip-end CVG array 48 for the LPT may be employed at the tips facing the compressor tip-seal shrouds, although the blade sections are quite thin.

These improvements to axial compressors generally mirror the methods and configurations taught for LPT stages, and allow for combinations of improved surge resistance margins, increased stage pressure-ratios, increased turning-angles, smaller lighter and less expensive compressor stages. Since the compressor absorbs about 60% of the energy consumed in the engine, efficiency improvements in these stages have a big effect on overall engine efficiency and engine SFC.

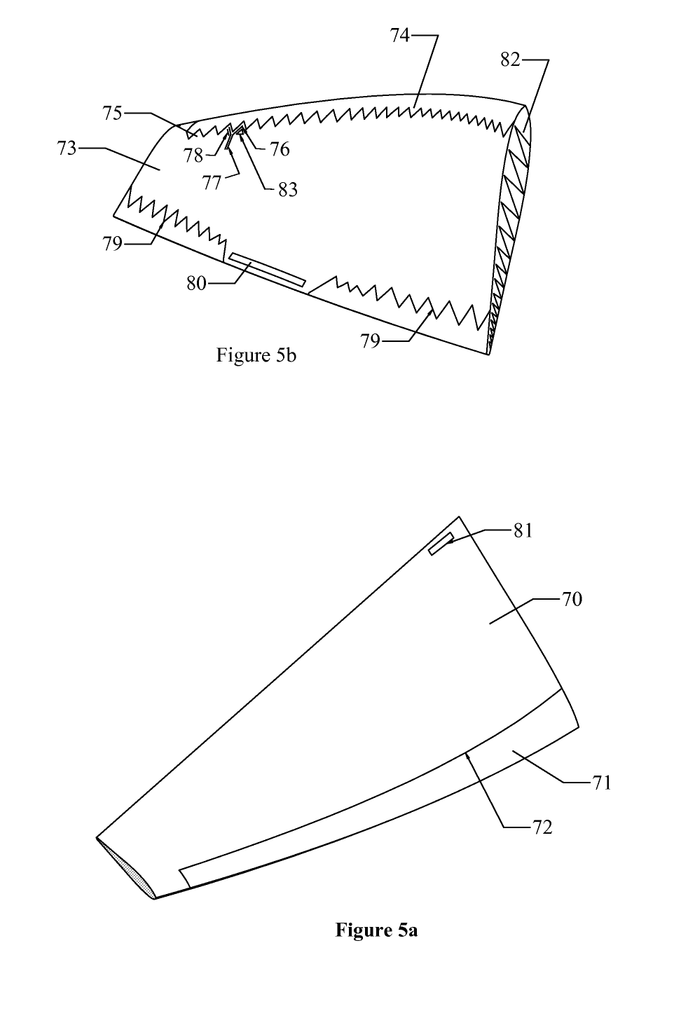

Fan stage: Fan cascades typically operate at much lower temperatures than e.g. HPT/LPT cascades and are larger, may require higher CVG step heights and have do not have as fine LE sections as LPC or HPC blades. FIG. 5 shows the outline detail of a typical existing Fan blade suction-face 70, protected at the blade LE portions from erosion by an attached Titanium or other metal LE EPS strip 71 typically emplaced and indented into the blade LE areas. To minimize flow disturbances the metal EPS transition 72, is essentially flush at the transition joint edge, but in operation the inevitable miniscule gaps open to create adverse BL tripping opportunities, and the erosive debris passing these component transitions tend to erode paint protection and material from the blade surface behind the LE which can further impair critical laminar flow performance over time and decrease fan cascade energy efficiency.

A CVG treated blade 73 is shown on the pressure-face with a CVG EPS overlay 74, which can be bonded over the existing unmodified item 70 and 71 with no other blade modifications required to an existing fan blade cascade. This CVG EPS overlay 74 operates on both the suction and pressure faces to; lower fan blade drag and input torque and engine power required for a given thrust, provide a higher stall AoA for improved dynamic response and resistance to flow disruptions at off-design conditions, reduce supersonic fluid-flow shocks and losses at the fan blade tips (by employing CVG tip-vortices to disrupt the SBLI lambda-foot BL separation mechanisms), and reduction of blade erosion with a consumable and optionally field replaceable element. Using CVG tip-vortices to disrupt the SBLI lambda-foot BL separation mechanisms and phenomena are viable on all other foil, blade and fluid-flow body surfaces at any realizable fluid-flow velocities and Re that induce sufficient vorticity, while also offering extended AoA and re-laminarization drag reductions.

The CVG EPS overlay 74 is operative at the engineered step heights, and this means the exit high energy flow back over the CVG steps is above the following post-step surface 75, and even with the initially downward-vectored post step flows, debris and sand etc. with higher density and momentum than e.g. the fluid-flow like air, will not have sufficient energy to make the downwards turn, but continue on and be subject to secondary flows and centrifuge outboard and loft clear of the more delicate blade body. This effect of reduced surface erosion on paint and materials behind the steps is visible on foils and body surfaces treated with CVG's.

The additive type CVG EPS overlay 74 can be fabricated as an elastomeric, plastic, metal, ceramic-coated substrate, carbon fiber, carbon-carbon, silicon-carbide or metal fiber matrix or ceramic matrix composite (CMC) or other material with the required mechanical and thermal durability and able to be formed by any forming process to conform aerodynamically to the existing blade LE and then be bonded to the blade or aerodynamic body surface. The CVG EPS overlay 74 may be formed as a single CVG element, but for larger span and curved LE blades CVG's may optionally be fabricated in varied geometry sections to be conveniently applied continuously in adjacent sections. Any blade fluid-flow discontinuities should be faired prior to CVG addition to yield best results.

Using asymmetric or varied-pitch and geometry CVG structures allows the CVG flow modifying action to be varied across the span so, e.g. at the areas of following localized shock-wave generation, the CVG pitch can be finer around that location to generate greater density of tip-vortex filament instances for differing SBLI effects, and not focus particularly on only optimizing drag reduction. Reducing body fluid-flow shocks allows a reduction of energy losses and/or improved latitude in operating regimes and on-design operating envelope conditions.

New design fan blades foil or body surfaces can now be configured differently, without linear protective LE indentations for prior art EPS components and to take full advantage of CVG improvements. Since the prior-art metal LE EPS sections may be denser than the blade body material, this can provide some weight savings before applying CVG EPS overlay 74 to get the benefits of CVG's. Another new design choice is to have a partial step-height integrated CVG array built into the LE volume that is then overlaid in register with a matched replaceable CVG EPS overlay 74 which can then be thinner and lighter.

New design fan blades also can benefit from optional added combinations of step-vortex expansion grooves 76, tip-vortex expansion grooves 77, step shear guide 78 and fluid-flow injection cavity 83 with a pressurized fluid-flow source, plenum and jets etc., as for e.g. the LPT blade. These are shown as single instances in FIG. 5b on the pressure-face and/or these may be applied on the suction faces as well. These grooves and structures provide a CVG registration and alignment mark and the option of greater improvements on wider blade chords, without requiring excessive step heights and CVG thicknesses and weights, and also allow the possibility of added separation control above the gains of CVG EPS overlay 74 and/or any additional integrated CVG step structures. This also minimizes the step height effects on the downstream foil or aerodynamic body surface design.

An integrated CVG and EPS strip combination that lowers fan blade drag and blade torque input e.g. about −10% provides big improvement in SFC and efficiency, since a modern fan disc has typically 5-10 times more cold bypass-nozzle thrust output than hot section nozzle thrust.

A replaceable and ablative CVG EPS component of the LE design combination also better protects the following blade surface and is beneficial since as the LE wear accumulates it disrupts the fluid-flows and BL at one of the most sensitive parts of the blade so replacement on inspection condition is of value.

A new design CVG treated blade 73 may have a symmetric or asymmetric indented TE CVG array 79 integrated at the chord rear, ahead of the trailing edge (tips facing aft), where the integrated CVG step indentation into the surface does not adversely compromise the body strength, mass distribution, flutter margins and aero-elasticity in this thin and high stress TE region. On the body pressure-face the fluid-flows may be designed to not separate until close to or at the TE, so the CVG's in this region have a thickening BL but reasonable fluid-flow momentum to work with at the designed step heights, limited by TE region surface thickness. The upstream CVG EPS overlay 74 provides tip-vortices that have generally expanded when reaching the TE region and will be tripped slightly outboard by TE CVG array 79, due to higher level centripetal secondary flows and CVG effects. In this case, close to the TE Kutta-Joukowski condition that defines and controls the body wake fluid-flow structure merging, the tripped upstream CVG tip-vortex filaments do not get chance to spin adversely spanwise before being subsumed into the TE wake vorticity vector-integrals, leading to the effective body circulation-defined lift. The TE CVG array 79 will add energized tip-vortex filaments almost directly in the TE wake, so additionally employing an asymmetric CVG form allows direct vorticity vector summation matching the implied combined body-lift tip-vortex wake direction, or the opposite sign, that allows geometrically controlled C_{L} modification, particularly at low AoA's, additively from either or both pressure and suction surfaces. In this manner CVG's may be usefully employed to affect the body fluid-flow wakes. These improved CVG EPS methods and combinations of performance improvements are also of value integrated into open-rotor turbofan concepts, helicopter rotors and conventional propeller blades, which share a range of fluid-flow concepts and design methodology.

This novel TE CVG array 79 arrangement is unlike Gliebe '240, Fritz '488, Vijgen '665, Shibata '436, Young '319, Balzer '106, etc., since it is a compact inherent surface structure and treatment wholly within the body extents and ahead of the original body TE and acts to; decrease BL fluid-flow losses between the aft facing CVG tips (unlike the prior art un-optimized non-surface vortices that induce only vortex energy losses), increase wake flow-mixing to reduce flow noise while employing a fundamentally drag-reducing structure, modify body-lift circulation and can be configured independently on both pressure and/or suction faces . It is possible to position and offset the TE CVG array 79 aft facing tips so they produce tip-vortex filaments from suction and pressure-face tips that are then effectively interdigitated just beyond the TE and cause minimum mutual interference before they sum into the TE wake vorticity.

The suction faces may employ TE CVG array 79, but effectiveness falls off at greater AoA's that induce thickened aft BL areas that have low energy or separation bubbles or fluid-flow detachment. These CVG improvements may be generally employed on any rotating and more effectively on non-rotating foils and surface bodies in Newtonian fluid-flows in the same manner to gain the benefits as taught here.

Fan blade tip chord sections are sufficiently thick to employ a tip-end CVG array 82, equivalent of the integrated tip-end CVG array 48 for the LPT, at the tips facing a fan tip-seal shroud. Additionally fan-tip to shroud clearance changes with temperature are less than turbine sections, and tip-end CVG's help with nacelle-ducting BL flow control on surfaces close to the fan tips.

For many foil or body designs there has been a lot of work attempting to employ well-known Gurney Tabs to modify C_{L} and C_{L} to C_{d} ratios and lower C_{d} ratios, but the theoretical work tends to incorrectly predict the impacts of tabs applied to foils and bodies in a Newtonian fluid-flow at practical Re values. Elastomeric lift enhancing tab, eLET 80 as a 3D shaped block is shown bonded at approximately mid-span of the pressure-face of CVG treated blade 73 close to the TE. Note that eLET 80 is typically best fabricated at a fraction of the span width, of 15% to 30% of the total span though this is not limiting, and employed at inboard from the tip on a rotating body, where fluid-flow velocity and lift contributions are becoming significant. The eLET 80 is typically configured as a block, vane or dual-vane structure at a height of between 0.5% to 3% of local chord width, though this value is not limiting. The setback of eLET 80 from the TE is about 0% to 500% of device height, and best results are generally for a setback of typically ˜100% of device height.

eLET 80 acts to generate a spanwise set of intense counter-rotating vortices stacked and trapped between eLET 80 and the TE edge location. These transverse vortex filaments act on the suction-face TE flows and tend to deflect these downwards at the TE and modify the local span section TE Kutta-Joukowski condition. The additional TE downward fluid-flow acceleration beneficially modifies the adverse suction-face pressure recovery gradient (reducing BL turbulent region thickness and drag) and also acts to effectively increase the local chord AoA and lift.

eLET 80 is implemented as a flexible and strong low-mass elastomeric material to as to not add excess mass in the aft and TE sections of the foil or body and reduce stability and flutter margins and is effectively mechanically transparent to the underlying body at the TE. Additionally, due to aero-elastic effects and vibrational dynamics of the underlying necessarily-flexible foil such 130 as; propellers, rotors or blades, a non-compliant mass added at the TE region cannot adhere reliably without distributed and non-focused local adhesive bonding shear-forces that allow the adhesives to fully load-share the intense acceleration forces to be distributed over the whole attachment surface area and not focus these at progressive slipping points. For these reasons non-compliant materials (i.e. non-elastomeric) are problematic to add in this challenging environment, and if done then create a vibrational stress focus and flexure problems for the underlying body that generates intense body material fatigue issues. Fabrication of a similar divergent trailing edge (DTE) structure faces the same real world challenges.

The small length sections of one or more instances of eLET 80 ensure the normally-adverse trapped spanwise vortex filaments have an expansion outlet as they accumulate and need to shed fluid-flow mass, and this typically occurs at an approximately 1,600 Hz rate, that is typically noted as a diagnostic acoustic-signature of fluid-flows when an eLET 80 is employed, and teach the novel importance of the vortex filament relief paths by employing a segmented or sectional application strategy. A further improvement in each instance of eLET 80 is to fabricate partial section-cuts mostly chordwise through the unit so that mechanical damage is limited to a sub-section, to effectively provide a rip-stop functionality.

A very slight angle on the formation of eLET 80 favoring the inboard end or outboard end allows the vortex filament outflows to be controlled in preferred shedding direction from either body end when summing into the TE wake, as additive or subtractive to the integrated vortex vectors generating net body-circulation and lift. A slight bend back on both sides from the eLET 80 body e.g. center allows streamwise vortex filament shedding and balance into the TE wake to be controlled as a geometric fraction of the fluid-flow masses processed by eLET 80, while the central transverse vortex acts to increase downwash for lift improvement.

Note that eLET 80 can be employed with or without CVG EPS overlay 74 or TE CVG array 79, but for dynamic stability reasons it is preferred to employ in combination with at least integral CVG method and CVG EPS overlay 74. TE CVG array 79 can be applied before or employed in sections between instances eLET 80. The FIG. 5b configuration of two shown instances of TE CVG array 79 between one instance of eLET 80 is not limiting, but indicates that CVG's can be configured across a fraction of the span or surface in combination with other features.

Tip unloading eLET 81 is shown as a small tab at the tip TE of blade suction-face 70 and may be added to reduce the chord section AoA lift in this foil area, and acts to greatly modify the foil tip-vortex, particularly on an open blade that has no great impediment to tip-vortex flows from pressure to suction faces. In the case of helicopter rotor blades this tab version acts to increase the spanwise loading inboard of the highly loaded tips, and a reduced and delayed local tip-vortex is less subject to shedding into the disc flows and creating blade vortex interaction (BVI) transient force loads, disturbances and acoustic signatures. Loading up the disc inboard also relieves some of the lift bending moment and spanwise strain loads on the foil structure.

The spanwise vortices induced at the forward-step entry face of the LE of eLET 80 are closely matched by the aft-step face vortices, so there is actually an unexpectedly minimal resulting chordwise pressure or aft force load on eLET 80 to challenge the adhesive bond attachment capabilities at significant impacting fluid-flow velocities and Re values. The entry and exit spanwise vortex filaments approximately balance and effectively shield the elastomeric TE masses from the expected incoming fluid-flow dynamic impact-pressures. The result is that the primary adhesive challenge is the intense radial accelerations. Testing on aircraft propellers generally confirms similar material capabilities and performance shifts possible, as for example a 12 gph to 10 gph reduction of cruise SFC, as about −18% energy saving reduction on an e.g. Lycoming IO-540 engine and a Hartzell variable pitch (VP) propeller combination.

Elastomeric material applied as eLET 80 at these high acceleration and fluid-flow velocity fields are novel and counter-intuitive over prior art, however there are manifest improvements and novel capabilities that indicate practical usage is justifiable. In the case of in-flight surface icing, the eLET 80 material is compliant and will allow transient buildup and constant shedding of ice since the loads here exceed the attachment capabilities of all but thin layers of moisture frost, so the greatest structural threats are from LE ice shed from inboard anti-ice systems that continuously shed small accumulations before they can greatly affect propeller performance. The compliance, robust deformation and elastic shape recovery characteristics, and sectional rip-stop damage tolerant application methodologies for eLET 80 allow new design capabilities on foil and body surfaces such as; blades, rotors, fan discs and propellers etc.

The IGV's behind the fan stage and before the compressor inlet may also employ add-on or embedded CVG's to lower drag and the extended AoA capability ensure mechanical IGV motions do not dynamically stall the fluid-flows. The stator blades leading into the cold section ducting that de-swirl the fan exit cold duct flows may also employ CVG's to reduce drag and extend AoA. Additional IGV's at e.g. the compressor and combustor outlets and other aerodynamic support and load bearing struts can employ CVG's with the same benefits already taught for any fluid-flow surface.

Surface flow augmentation from pressure-face pickups, or other fluid source such as e.g. cooled compressor bleed-air, may also be employed on a new design fan blade, with equivalent structures to the LPT jet fluid injection port 37, fluid-flow injection cavity 36 and injection plenum 38, scaled for the larger fan blade to improve fan blade; operating AoA and drag performance, as for the LPT cascade already noted. This integrated CVG array method with augmenting jet fluid injection ports can also can be extended to new design helicopter rotor blades, propellers and even fixed foil or wing surfaces with suitable geometry scaling.

A jet engine power-core (compressor, combustor and turbine) employing CVG's for improvements may use an LPT output-shafting (or similar power extraction stage) to drive a fan disc cascade for jet cold duct thrust (as prior art) or be configured in a turbo-shaft configuration to drive external loads or gearboxes driving devices such as; a propeller, rotor system, an electrical power generator, a pump or a compressor used for e.g.; refrigeration, a natural gas pipeline or industrial scale chemical processing system like a refinery.

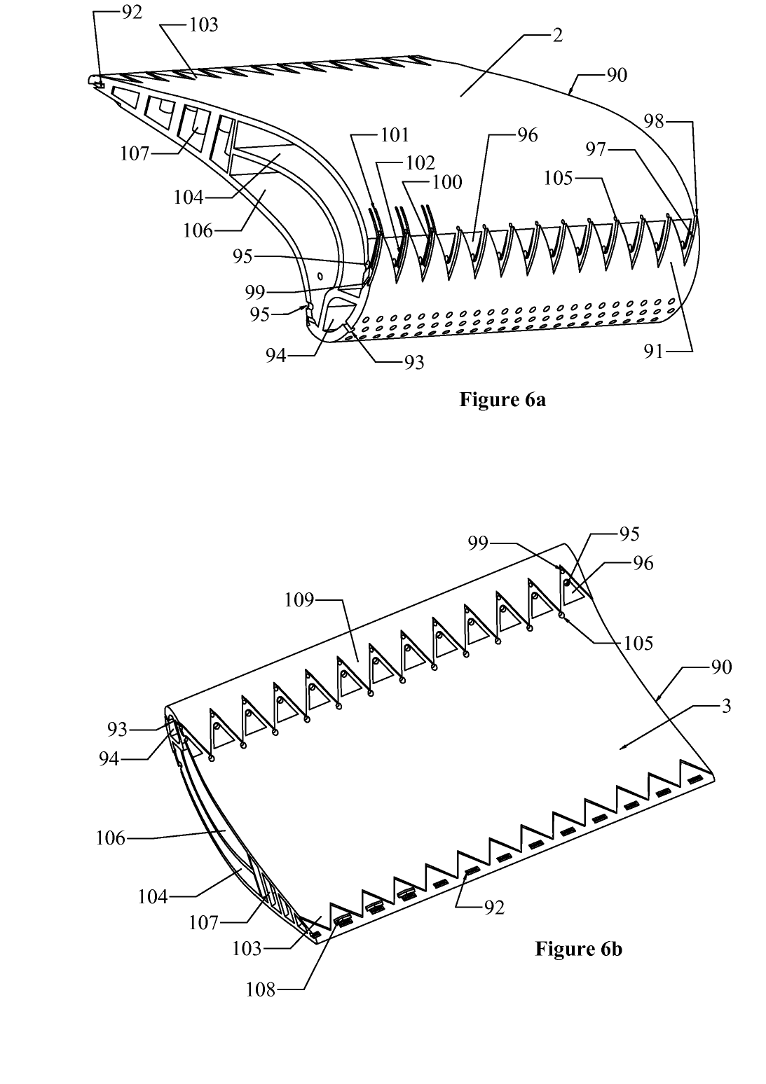

HPT turbine blades: FIGS. 6a and 6b are a representation of HPT blade 90 with a deep reaction-bucket type foil section and has attached components, or embedded, integrated upper face CVG array 91 and an integrated lower face CVG array 109, that operate in the same manner as the LPT blade already taught, to extract energy from the incoming fluid-flows from the combustor and then power upstream compressor stages or loads. Integrated HPT CVG's are configured for reduction of drag and AoA extension to reduce fluid-flow separations/turbulence and also mix-down of heat loads. Integral CVG's fabricated in the base metal provide greatest HPT blade strength, but since multi-part HPT blades may be fabricated to provide all the disparate characteristics required, it is also possible to have a high temperature LE CVG array with suitable silicon-carbide or metal fiber matrix or ceramic matrix composite (CMC) 3D structures interlocked into a new design HPT LE in a cascade.

For IGV's or first HPT stator and first HPT rotor disc the combustor outlet temperatures are above the typical nickel superalloy melting points, so these surfaces are fluid cooled. A cooling jet fountainhead 93 is located at LE of stator and rotor blades and is fed cooling fluid (typically HPC bleed air at a cooler e.g. ˜650 degrees Celsius) from the fountainhead cooling plenum 94. The fountainhead has sufficient angled jets and flow mass to cool and protect the foil LE and this cooling fluid then splits and flows around the pressure and suction faces to provide additional surface cooling and reject heat-flux and thermal loads into the foil wake. The foil surface is the lowest local temperature, and travelling higher in the BL into the freestream fluid-flows the temperatures raise closer to the combustor peak temperatures. Any excess turbulence on the foil or body surface such as fluid-flow separation bubbles and detachment turbulence will typically mix-down the higher heat fluid and temperatures layers and increase the heat flux that has to be removed to safely cool the surfaces.

Prior art foil surfaces are additionally cooled with internal-face skin cooling with serpentine galleries and plenums that feed into additional downstream angled cooling jet arrays, and also internal pin grids 107 and TE cooling exit slots 92. The challenge is to have adequate jet surface cooling fluid-flows without jet-liftoff that generates excess turbulence and heat mix-down, and to get efficient spread of surface cooling and buffering from higher temperature fluid. CVG's provide a low-drag method to provide effective and well-spread cooling fluid injection at the lowest BL levels, as optionally used for the LPT bodies for just improving separation control. Aft-angled jet fluid injection port 95 or metering orifice that can convey cooling fluid-flows from e.g. an upper CVG cooling injection plenum 104 into a fluid-flow injection cavity 96 at the surface behind the aft-facing step 97, and located between the CVG tips 98. Adding a cooling fluid jet in this aft angled manner exiting into a shaped cavity takes advantage of the initial downward velocity vector of the CVG step exit high energy flow to suppress jet-liftoff at high blowing and cooling flow momentum-ratios and helps to spread the cooling fluid stream laterally and into the lowest cooler levels of the downstream BL. A second lower CVG cooling injection plenum 106 also feeds higher-pressure cooling fluid to adjacent blade surfaces and instances of jet fluid injection port 95 and associated structures at the pressure or lower face CVG array 109, in locations laid out in the same manner as the HPT suction face.

To cool the step-vortex mass-flows an additional step-vortex cooling injection port 99 may be located at the bottom of the CVG valley. To add in extra cooling to the CVG tip-vortex filaments to unload heat fluxes on downstream surfaces, a tip-vortex cooling injection port 105 may be included at the base of the CVG tips 98. Other prior art cooling methods like internal serpentine cooling passages, turbulators, TE and tip “squealer” cooling ejection and pin grids 107 can be used in conjunction with integrated CVG's and internal passage and internal skin flows to cool HPT surfaces. Efficient use of lower flow mass optimized cooling fluid-flows that remove the heat fluxes improves engine efficiency, since it costs compressor input energy to derive the cooling fluid-flows. Surfaces in this HPT stage may employ any prior art oxidation reducing coatings and other metallurgical methods and alloys for low and high cycle creep etc. Step-vortex expansion grooves 100, tip-vortex expansion grooves 101 and step shear guide 102 may also be optionally integrated (as for the LPT section) at HPT suction and/or pressure CVGs to allow adjustments to step-vortex mass flow capacity as balanced against the surface mechanical strength requirements and design step size.

Additional relief from high heat fluxes may be provided by TBC at e.g. the LE sections, and these typical ceramic surface layer coatings decrease surface heat conductivity to reduce heat fluxes, at the cost of increased mass and risk of coating spalling, protection loss and surface burn-through. With integrated CVG's and jets/injection cavities providing efficient surface cooling and dispersal means, the sections of a foil downstream of the CVG steps are less likely to require the added mass and complexity of a large area of TBC.

In the balance of rotor, stator end-walls and fillets in the cascade passages and ducting surfaces, it is possible to also employ CVG's to provide additional low-drag jet fluid injection port cooling structures as for foils, and adds the ability to cool below the BL in areas of adverse secondary flows that are resistant to disruption by e.g. the blade passage-vortices etc. Fillet surfaces may employ CVG's with jet fluid injection ports on these highly contoured surfaces. Integrated CVG tip-vortices also provide a measure of SBLI control capability and can be configured to modify passage-vortices, shocks and secondary flows.

A secondary integral CVG array 103 close the TE cooling exit slots 92 on the pressure-face may be employed to minimize blade wakes and improve lift/vorticity since they are immediately before the blade TE so are less adversely affected than integrated CVG's employed as a second row close to the e.g. upper CVG array 91. A lift and TE cooling enhancing tab array 108 may be added before the TE cooling exit slots 92 and this option allows modification of both blade effective AoA and helps to spread the slot 92 cooling flow along the TE, with or without the array 103. This tab array 108 may employ “bent” or angled tabs as shown. A secondary integral CVG array 103 may also be added to the suction-face of the HPT blade.

Intermediate pressure turbines (IPT) may also require cooling, and these can be designed as for the HPT blade, to improve cooling and drag losses. The CVG and associated design features shown herein may be integrated in any combinations, instances and locations, along with prior art methods of blade and surface design to provide optimum performance. Note that a CVG treated HPT blade may also be employed as an embodiment for example in a steam turbine, with useful improved fluid-flows and efficiency, and a LE surface coat material may be used for erosion protection that may also incorporate the CVG structures. The lofting and clearance of erosive particles and material downstream from the CVG steps also help protect downstream flow surfaces. For steam turbines incoming fluid-flow is from a combustor/steam source, and a compressor may not be needed, so the bulk of derived turbine power may drive other loads.

Centrifugal compressor: Many smaller compressors and pump devices, e.g. jet engines at the final HPC stage, employ a centrifugal type impeller since it is a; compact, high compression ratio, weight efficient, rugged and low complexity device. There are many fluid-flow similarities between an axial, mixed-flow and centrifugal compressors and pumps, where the centrifugal blade or vane cascades on an impeller have increasing root and tip diameters along the impeller axis towards the exit, and the exit flows may be fully radial or mixed (as partially axial) into a downstream ducting and/or diffuser structure.

Centrifugal compressors (and pumps, when employing a liquid state Newtonian fluid-flow) can suffer from suction-face flow separations at the; impeller tips, diffuser guide-vanes, vanes (or blades) and any other flow surfaces, that cause fluid-flow performance problems and energy losses. Many impeller vanes are aft-swept at the exit flow angles so as to be less aggressive on tip momentum transfer and flows to reduce fluid-flow separation stresses at the blade exit-angle. Flow detachment or separation bubbles in low pressure areas of a Newtonian working fluid like liquid water or ammonia will manifest themselves as a change of fluid state from liquid state to the vapor/gas-phase in entrained physical bubble structures, adding the extra complexity of eventual rapid or supersonic bubble-structure collapse, cavitation and potential damage mechanism from strong supersonic shock and acoustic waves.

Adding integrated CVG's in line with fluid-flows and streamlines on centrifugal device suction-faces and other flow surfaces allows control of gas-phase fluid-flow separation bubbles and reduces drag and turbulent BL flow losses, as taught for cascades earlier. For a liquid phase fluid-flow in suction regions, fine CVG vortex-filaments intercept and disrupt vapor bubbles forming and growing in fluid volumes dropping below the liquid to vapor-pressure transition, before they can grow to sizes that can cause cavitation damage. This bubble disruption also reduces the resulting shock energy and acoustic signatures, and vortex filaments also act to diffuse, reflect and attenuate the shock pressure and acoustic waves in the working fluid.

FIG. 7 shows a typical open-form centrifugal impeller surface and hub inner wall 120 with stylized features seen on most open-form impeller versions. This example has a central impeller inlet flow guide 121 leading into the LE of the array of impeller foils or inducer vanes 122, and as a compressor rotates anticlockwise viewed into inlet flow guide 121. Incoming axial fluid-flows are acted upon by the axial rotation of inducer vanes 122 are accelerated and continue across the hub inner wall 120 and then exit radially with higher momentum and velocity at the vane exit tips 128 and cross over to an array of optional stationary diffuser guide vane 129 (only one instance depicted for clarity) that then feeds the fluid-flow into the final output fluid-collection method or volute, ducting etc., not shown for clarity. This FIG. 7 example also employs additional fractional vanes 132, so as not to choke the entry flows earlier on the inducer vanes 122.

An integrated entry suction CVG array 124 may be embedded on the suction side of the inducer vanes 122 portion near the vane entry LE to help ensure fluid-flows do not separate (or cavitate for liquids) on the suction-face of the vanes. An integrated downstream suction CVG array 125 may also be integrated when the impeller geometry and streamlines allow for beneficial action. On the opposite side of each vane at integrated pressure-face CVG array 123, it is also possible to integrate a complementary integrated pressure-face version of CVG's and these work in similar manner and different locations from LE as on e.g. an LPT blade to lower flow losses on the vane pressure faces. Location of these integrated CVG arrays follows the; structure, logic and procedures as for e.g. LPT blades and are then optimized in geometry, flow angles and locations to adapt and match the unique impeller geometry, where final testing confirm the best combinations on a real impeller and centrifugal compressor, pump or turbine design. CVG sizes and angles shown are merely representational for discussion, and do not limit the actual designs chosen and optimized.

The pump root or hub inner wall 120 is a large surface area of convex and concave surface primary flow BL and some secondary flows between suction and pressure faces in the same blade or vane passages. This surface may be subject to flow or cavitation problems in suction regions and CVG BL re-laminarization will also reduce drag or cavitation, so integrated inner wall pressure-face CVG array 127 and integrated inner wall downstream pressure-face CVG array 126 may be employed to help here, and as for any CVG, may be angled slightly to best match the local fluid-flow streamline conditions. If the vane hub roots are filleted then integrated CVG's can also blend across these fillets and even merge with other CVG's on the adjacent surfaces, although this figure does not show vane to hub blending fillets explicitly.

Stationary diffuser guide vane 129 foil or surface, if present, also may employ an integrated diffuser suction CVG array 130 to control separation bubble losses from the intense fluid-flow pulses and wakes coming from the high velocity vane exit tips 128 at the dynamic flow exit-angles and diffuser effective AoA. Since the diffuser guide vane 129 can be configured de-swirl the incoming impeller fluid-flows and is operating in a stator mode with non-rotating flows, it may also employ an integrated diffuser secondary suction CVG array 131 to lower drag or have higher surface curvature for a more compact diffuser section. The pressure-face of diffuser guide vane 129 may also have similar integrated diffuser pressure CVG arrays to reduce flow separations and drag as well. The flow sections of the static ducting and piping around the array of diffuser guide vane 129 and blending fillets may also employ integrated CVG's to further control drag losses and flow separations.

Also not shown in FIG. 7 is the matching 3D fixed or bounding tip-shroud duct control surface that on an open-form impeller closely matches and clears the moving structure of the open-form impeller tip edges 133 to ensure lowest back-flows from downstream fluid volumes. These vane edges are equivalent to the open-form tips of axial blades, and a closed-form centrifugal compressor impeller is equivalent to the axial cascade form with continuous interconnected tip-shrouds, so the inner vane passages are fully enclosed.

A tip-end CVG array 134, functional equivalent of the integrated tip-end CVG array 48 for the LPT may be employed at the vane tips facing the centrifugal compressor tip-seal shrouds, although the blade sections are quite thin, small CVG's can operate effectively at high velocities and small gaps with high shear forces. Heat loads in centrifugal compressors are less than turbine stages, so tip expansion clearances can be closer, with lower losses.

Tip-end CVG array 134 is angled so as to induce vortex filaments on the closely matching shroud surface to control its BL development and flows, at the vane passage rate as it sweeps over the shroud surface. Tip-end CVG array 134 step-down may, or may not, intercept and cut the vane tip end LE, and with the configuration of step that does not cut into the LE, the inherent tip to shroud seal clearance is maintained at the tip LE with the CVG step-down occurring downstream of the LE in the local gap flows. As a compressor impeller in FIG. 7, the vane pressure-face is to the right of tip-end CVG array 134 and the suction side is at the left, so these CVG tip-vortex filaments stream at distributed locations along the tip chord to the left and downstream from the pressure to suction-face direction, in the same direction a normal foil or body surface tip-vortex occurs at the body tip TE, such as the tip corner conjunction of items 128 and 133. Applying a higher mass-accumulation step angle to some of the tip-end CVG array 134 members (such as e.g. 60 degrees) additionally allows formation of an oversized step-vortex, bound to those steps to act as a flow impediment for the energy losing flows through the tip-shroud gaps and seals driven by pressure-face fluid.

The bounding tip-shroud duct control surface may also have arrays of CVG's emplaced on its surface in e.g. a radial or spiral pattern to control local BL flows under influence of vane pass-by, and these may be employed, with or without tip-end CVG array 134, and configured so this CVG pitch is not synchronous to the vane pitch, so as not to create coherent high pressure waves or acoustic signature. For additional flow attachment capability an angled additional flow-control injection jet 135 may be added after a CVG step to increase the momentum in the lower BL, and the pressure fluid source for this is harvested (and maybe cooled) and conducted from the compressor output flow and ducting, through the impeller axis and into a plenum in the impeller core that can distribute these fluid-flows to the surface CVG's as required for instances of 135, since upstream impeller surface-flows are at lower pressures. In the compressor and turbine cases this injection jet can dispense cooling fluid that is derived from a higher pressure fluid source that is cooled. Instances of optional step-expansion grooves and/or step shear guide may be added to the impeller, but are not shown for drawing clarity.

A centrifugal compressor, at a first approximation, may be reversed to operate as e.g. a radial inflow centrifugal turbine. In this case the impeller torque input becomes an output and the suction and pressure faces are transposed and any CVG arrays can also be changed to provide the desired BL and flow modifications. As a centrifugal or mixed-flow turbine, instances of additional flow-control injection jet 135 can now be used as for e.g. the HPT stator and rotor blades for surface film-cooling as well as flow attachment improvement.

For a closed-form impeller the tip shroud connects to the tips of all the vanes to form closed vane passages, so CVG's can be employed on all these internal flow surfaces and tip seal labyrinths etc., for BL and separation control, in the same ways already discussed.

Integrated CVG treatments on centrifugal vanes, impeller and other flow surfaces allow increased entry and exit-flow turning-angles to allow the design of a new, more compact and lighter; compressor, turbine, pump, turbocharger and similar fluid-flow structures, or can be used to just reduce suction-face or fluid-flow energy losses, TG vortex and BL thickening losses on concave faces, on existing designs with a mechanically-compatible improved performance ‘drop-in’ replacement impeller.

Integrated CVG's are also useful on other centrifugal or mixed-flow types of fluid-flow pumps, turbines, propellers and compressors such as industrial scale process-gas compressors (e.g. ammonia refrigeration, or natural gas pipeline compressors), water jets and pumps or turbines for water or other liquids.

Turbochargers employ coupled centrifugal flow compressor and turbine impellers, so are also an example of a centrifugal turbine extracting fluid-flow energy and adding this energy into the fluid-flow in a centrifugal compressor, and both types of centrifugal device may employ integrated CVG's throughout adjusted for the local flow conditions as a new design to improve efficiency and operation.

Nacelle structures: An engine nacelle is an example of a generally cylindrical flow-body attached to a fuselage or wing via a pylon, mounting device or attachment link, with mutual fluid-flow interactions. Any adverse pitch and yaw to the incoming fluid-flows on this attached flow-body can generate significant drag forces and turbulent flows due to flow separations on e.g. downstream suction surfaces. Engine nacelles are integrated into the engine entry and exit fluid-flows to ensure correct entry and exit conditions for the enclosed engine.

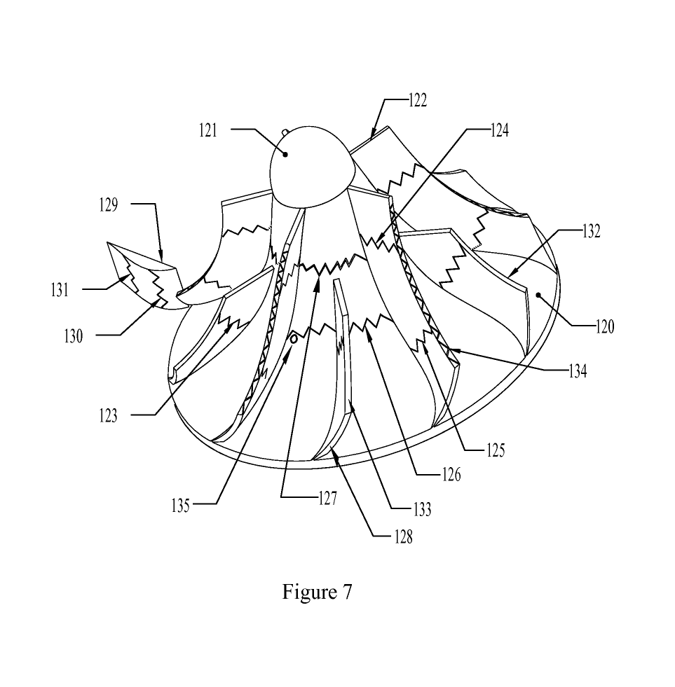

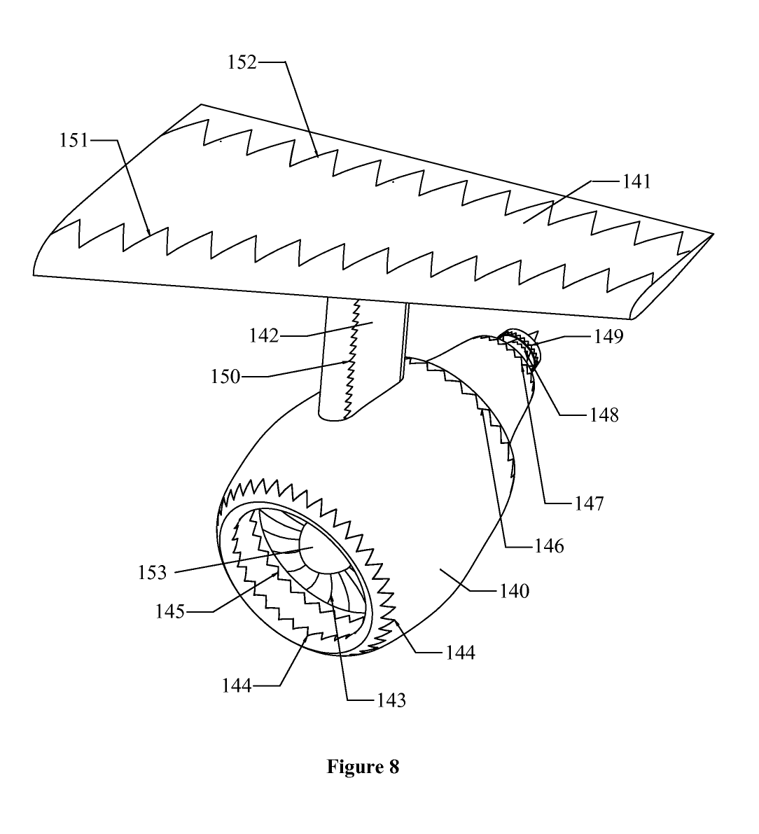

FIG. 8 shows the generally cylindrical nacelle body 140 attached to a wing body 141 with an attachment pylon 142. For a turbofan engine example, fan blade cascade 143 is shown at the nacelle entry after duct diffusion has taken place in the nacelle LE and entry cold duct sections. Integrated nacelle LE CVG array 144 is shown at the LE to improve flow attachment and reduce drag on both the nacelle internal duct and/or external surfaces. This LE CVG array 144 may also be augmented with an overlay of matching and replaceable EPS CVG elements if surface erosion and/or durability is a problem.

A further integrated fan entry CVG array 145 is shown to improve duct flows into the fan blade cascade tips, and reduces the need for active suction BL control at the fan tip entry location. Similar integrated CVG arrays may be designed into both faces of the internal cold ducting to ensure that flow separations on convex and concave duct faces are avoided and turbulent BL drag loss is minimized These integrated ducting CVGs allow for a higher duct surface 3D curvature or shorter ducts and engine size for new designs. A series of CVG's can be employed 1660 on these large surfaces at a suitable spacing where the tip vortex filaments have expanded and before they burst, or the BL flows become susceptible to separation bubbles or excess thickening losses. This defines the closet sensible CVG spacing and fluid dynamics defined separations. Since most modern nacelle new designs are molded composite structures, it is straightforward to incorporate integrated CVG arrays in design and fabrication for improvements in energy efficiency and capabilities.

At the cold duct exit nozzle it is also possible to embed integrated cold duct exit CVG array 146 on external and/or internal surfaces ahead of the local cold duct TE to; improve flow mixing, cold exhaust and fan exit noise signatures, along with drag reductions. At the hot section nozzle exit, similar integrated hot duct exit CVG array 147 can be integrated into external and/or internal duct surfaces ahead of the local TE, and/or to the exhaust cone 148 to improve flow mixing and eddy breakup and improve exhaust noise signature with drag reduction. To break up intense hot exhaust crackling, additional low-drag thin cylindrical ring(s) of eddy breakup CVG array 149 may be added in the expanding exhaust flow stream e.g. between the exhaust cone 148 and the hot section duct TE to induce vortex filaments into the bodies of the expanding hot exhaust eddies to disrupt and break eddies up, before they organize to conduct more acoustic noise and shocks into the wake transitions. The support struts for this eddy breakup CVG array 149 and the turbine aft support struts in the exhaust flows may also have integrated CVG arrays to add additional vortex filaments for exhaust noise management.

Nacelle attachment link or pylon 142 employs flow blending fillets into the supporting wing and nacelle bodies and may also have a pylon LE CVG array 150 added to improve flow and reduce drag around the (mostly vertical) pylon surfaces. A wing may have an integrated wing LE CVG array 151 and a secondary wing CVG array 152 (particularly in the pressure face).

Other structures attached via links or pylons may also use CVG's to control flow separations in flight and for a closed entry flow-body like e.g. a fuel tank or weather-radar pod, etc., the forward body is a nose tip, like fan spinner 153. Since 153 is spinning with resulting angled entry airflows, it can also use an angled CVG array. Nose tips may have a conforming nose cap with suitably angled CVG's, or be designed with an integrated nose CVG array to lower drag.

These attached flow-body structures also are effectively a form of closed (and/or open ended) “inside-out” ducts, with the primary fluid-flows and losses on the “outside” flow surfaces. In some cases, flow-body embodiments with a pre-defined kinetic and/or total energy may need to be detached or jettisoned for free-flight, such as the Virgin Galactic “Spaceship One” detaching from a launch platform, or a flow-body like a projectile. In these cases as well, application of CVG's will improve the flow-body energy efficiency (i.e. range) and the fluid-flow dynamics of attachment and/or separation, and motion, which also allow improved trajectory and/or path stability.

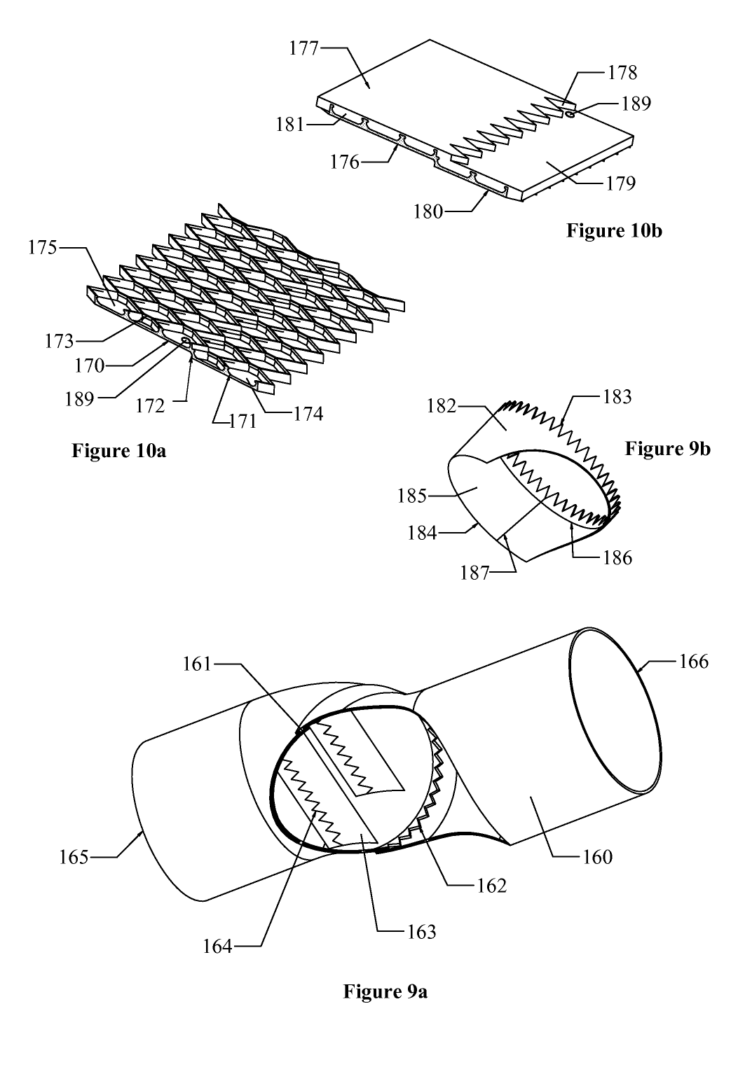

Duct flow paths: A large portion of the surfaces of most fluid-flow devices such as a jet engine are composed of ducting surfaces to direct fluid-flows to the optimal design positions in and out between different fluid-flow processing sections, and these are limited in the flow turning-angle or flow-directing they can introduce before they induce fluid-flow separations or BL thickening that cause energy losses. These ducts or piping and even exterior 3D surfaces are other flow devices that can be improved with integrated CVG's. FIG. 9a shows a typical fluid-flow duct 160 that is an analog of many conditions in fluid-flow surfaces, ducting and piping instances. The cut-away section shows a duct seam 161 at the flow direction change and the smaller diameter upstream duct 165 has internal duct CVG array 162 structure integrated in its TE end, that then is placed inside the downstream duct 166 at an optimum location and merged with e.g. swaging and brazing or welding to seal and complete the improved pipe or duct joint. This is one design embodiment that allows a duct or piping transition with an internal integrated CVG array and this acts to reduce flow separations and drag on downstream duct or pipe convex surfaces, and drag reductions on the concave surfaces, when surfaces or ducts change direction or diameters, in the same way as for foil or other body surfaces in a freestream fluid-flow as disclosed. Depending on the duct or pipe fabrication method, material, diameters, wall 1715 thickness and section geometry any number of e.g. stamping, forging, forming and machining steps may be used to incorporate a CVG array at an optimum location on the inner surfaces, or outer surfaces if the fluid-flow is on the outside of the body surface.

FIG. 9b shows a duct insert CVG array 182 that may be introduced into the straight section of constant cross-section duct or piping of slightly larger diameter, and then swaged or otherwise attached at the best position with the duct insert CVG tips 183 pointing downstream in the fluid-flows. In this case the duct insert entry 184 has a very thin and sharp edge to minimize entry flow disturbances and the duct insert entry surface 185 has a very shallow angle back to step thickness point 186. This long low-angle duct convergence provides the minimum flow change and disturbance before reaching the correct step-height duct conformal section at step thickness point 186 before entering the CVG steps. An optional duct insert slit 187 may be introduced to make it easier to insert a slightly collapsed duct insert CVG array 182 into a duct and then expand and interlock it into place, or employ an attachment method to secure the device. A streamwise gap in the array is permissible and has minimal performance impact. Note that between step thickness point 186 and tip 183 the flow stabilizes as parallel to the mean duct surface and so when crossing the CVG steps has the optimal surface vector to get best flow shearing actions and downstream BL reenergization. A key attribute of these duct CVG arrays is that they operate continuously across the whole duct surface BL flows they intercept, in that there is no BL unmodified between the maximum cross-flow extents of the V-form CVG array, between fluid-flow input and output plane cross-sections, including the case where the array circumscribes the whole duct perimeter. In the less optimal case that the CVG array does not have streamwise room for a constant step height section (negating a primary benefit) this continuity of cross-flow BL modifying function distinguishes these type modified CVG arrays from a grouping of the prior art discrete VG's. Employing duct insert slit 187 also allows the duct insert CVG array 182 to be alternately fabricated in an essentially spiral form with CVG intercept angles modified for the helical angle, so as to intercept the duct wall BL flows at the optimal angles. If the spiral is applied for more than one turn there will be a drop in efficiency, depending on the decay rate of the upstream vortex filaments before encountering the next downstream CVG v-form steps. This means applying a series of duct insert CVG array 182 in the flow direction requires them to be optimally spaced apart to get best effects.

Application of CVG's to internal pipe and duct surfaces may also be made by a spray-on or formed coating materials that can; be applied or squeegeed when pliable, machined or abraded into the correct surface geometries. These coatings may be built up in several layers and also provide mechanical and corrosion/chemical protection for the underlying duct or pipe surfaces.

Another flow control option is for prior art internal flow-turning vane 163 at duct flow transitions that allow ducting to introduce a large flow-turning, but these structures introduce drag since they operate like a foil cascade to change the fluid-flows. Flow-turning vane CVG array 164 may be integrated into suction and/or pressure faces of flow-turning vane 163 to lower drag and allow larger duct or pipe turning-angles before flow separation, and also allow new e.g. pipe, duct or s-duct designs with more compact geometries and/or lower energy losses.

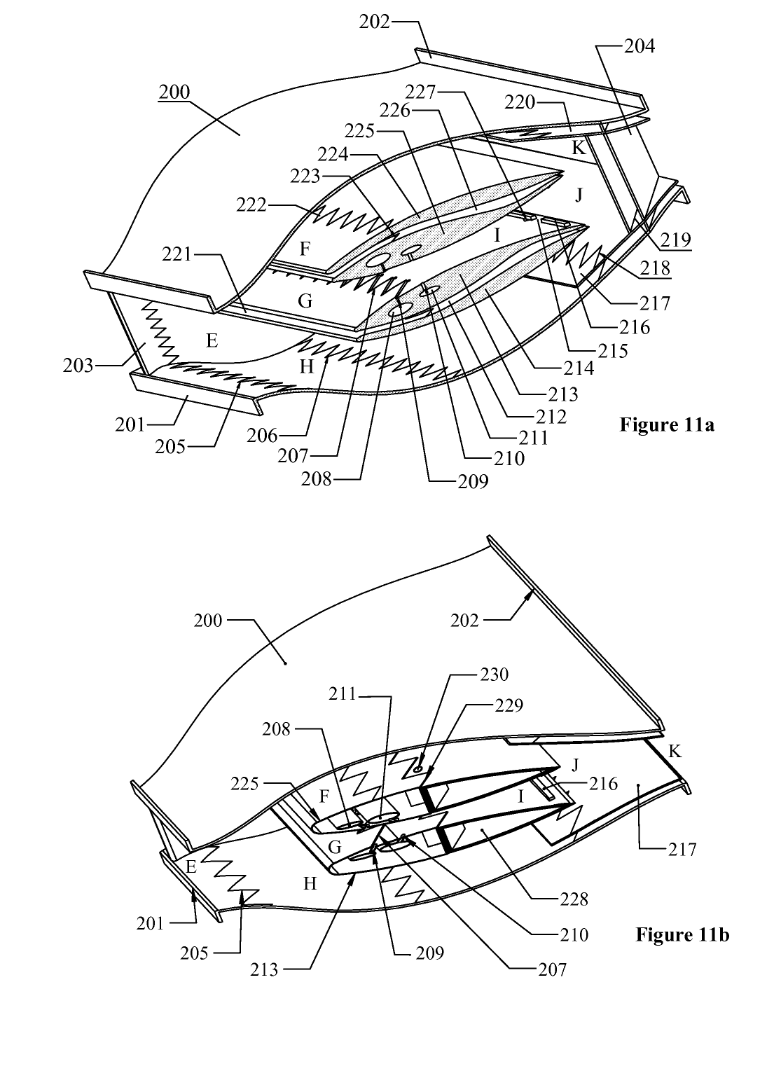

For larger duct surfaces and transitions, that may also require heat resistance, it is possible to emboss a tiled pattern of e.g. triangles, rectangles, hexagons or other polygons that stiffen and improve strength and mechanical efficiency of a cooled ducting panel component and allow the integration of CVG's and the option of adding a strongly retained and anti-spalling TBC coating. FIG. 10a shows a cross-section of wall duct that has been stamped or embossed with interlocking hexagonal cells that may optionally have an integrated CVG step functionality. Downstream smooth duct surface 170 (on opposite face in FIG. 10a) in contact with the fluid-flows, is located to the left and below (downstream of) embossed CVG step array 172.

Embossing initially raises vertical walls 173 with a significant wall-supporting root junction radius 171 (with this radius greater than a right angle, and up to the wall height) which creates an interlocking array of beam sections with larger moments of inertia and lowest stress focus (as clearly distinguished from the sharp-radii right-angled wall base junctions of Lutjen '342) and best strength and thermal resistance to remove heat fluxes from upstream inner floor 174 and downstream inner floor 175. The tops of the vertical walls 173 can also be additionally deformed to compact the sharp wall edges into a lip and increase edge rigidity and resistance to handling damage. Cooling air can flow across the edges of vertical walls 173 to remove heat, with good thermal conductivity and mixing down to the wall and inner floor surfaces beneath. Depending on the alloy used, to minimize material disruptions due to forming stresses, it is best to perform this embossing or effectively forging method at the metal plastic temperatures (preferably en-vacuo) which also allows close control of the material temperature distribution, surface oxidation and minimum compression/embossing die forces. It is also possible to create these surface arrays and steps with other e.g. investment casting processes, explosive/hydraulic die forming, etc.

Fabricating this improved duct panel section of FIG. 10a also allows the integration of a TBC into the unsmooth face sides. FIG. 10b shows the embossed upstream duct panel area 176 with a covering upstream TBC blanket 177 facing a hot fluid-flow, which leads into a TBC CVG array 178, and then down to the downstream TBC blanket 179 covering downstream duct panel 180. Note that the hot fluid-flow is against the TBC side in this arrangement, and is the opposite side and flow direction of the similarly formed part in FIG. 10a. This embodiment takes advantage of the e.g. hexagonal array and formed tops of vertical walls 173 to securely retain sub-sections of the TBC, such as locked TBC element 181. The TBC coating may be applied with any of the well-known TBC application methods, materials and inter-coatings. The cracking of the thinner TBC sections between retained locked TBC element 181 instances can be controlled by the TBC application temperature of the metal substrate. This presets the mechanical stresses due to differing thermal expansion coefficients between the substrate and integral vertical walls 173 and the TBC sub-sections or lamellae. This can be set between operating temperature or cold conditions to inhibit TBC cracking or allow the coating to fracture uniformly into retained locked TBC element 181 instances. After TBC coating the step area can be machined or abraded to provide the best step edges of TBC material for TBC CVG array 178 and the rest of the TBC surface may be processed similarly for surface uniformity.

An angled additional duct flow jet 189 can be provided downstream of the steps of TBC CVG array 178 or embossed CVG step array 172, and this jet (or jet array) can conduct in a surface film-cooling fluid-flow, and/or an additional BL energization flow from a pressurized fluid-flow source under the step area, as taught for e.g. the LPT stator foil, since this is a fixed surface. Instances of optional step-expansion grooves and/or step shear guide may be added to the duct surfaces at the CVG steps, but are not shown for drawing clarity.

FIGS. 10a and 10b show essentially a planar panel, but this processing may also be applied to surface arrays and steps with 3D curvatures for application in sections in any ducting surface configuration. These hexagonal features may employ the best CVG flow-angles e.g. approximately 22 degrees in the downstream edges, and a triangular or diamond form may be used for smaller TBC sections but will result in a higher metal mass ratio in the walls versus floor sections. Typical duct sections may be from about 0.5 mm to 3 mm thick, but this is not a limiting condition, depending on working pressures etc., and the wall, floor, polygon type and sizes and TBC thicknesses can adjusted as required to meet the design requirements. Cooled turbine blades may employ these polygon retaining features to anchor a LE surface TBC coating against high inertial loading, and in this instance, if a fountainhead arrangement is required for LE cooling this can be pierced after TBC coating and step machining, etc. Post-step blade cooling of surfaces without TBC would then be via cooling flows introduced by e.g. aft angled jet fluid injection port 95 instances, internal blade skin cooling and TE cooling slots.

Pipeline pipes, general-use tubing, nozzles etc., may incorporate or be fitted with suitably spaced CVG's to reduce surface drag and energy efficiency. For spiral-welded or rolled pipe, embossed or machined internal CVG's can be easily integrated with any compatible fabrication methods prior to roll forming and welding. Note that it is important that the CVG repeat spacing be sufficiently large so re-laminarization can occur and the tip-vortices can expand, otherwise the result will be adverse to drag, like a prior art turbulator or conventional VG array.

Conformal Vortex Combustor: FIG. 11a shows the general arrangement, as an oblique partial cross-section of a sub-segment, of an annular compact and efficient conformal vortex combustor or gas-generator design employing integrated CVG's to provide an improved design. Combustors may receive the output of a compressor, provided as an oxidizer to burn a fuel input in a controlled exothermic reaction to generate heat and/or create an accelerated fluid-flow from which work may be extracted.

An outer combustor pressure wall 200 connects to a HPC casing via the input interface 201 (connecting to HPC at outer and inner walls), and also connects to the HPT casing by the output interface 202 to maintain high-pressure integrity, since the combustor typically is the highest pressure region of a device. Combustor input guide vane 203 and combustor output guide vane 204 act to define the circumferential extent of this combustor sub-segment in a total combustor array and volume. These combustor guide vanes 203 and 204 can be optionally angled to the axial flows and twisted, and be used as part of the stator structures to diffuse and de-swirl the HPC output flow (using 203) and/or also define the combustor flow output-angles in the radial dimension and so effectively act as a compact and integrated HPT entry stator blade (using 204) with sufficient cooled vanes to allow the design of optimum flow output-angles directly into the HPT first rotor cascade.

The combustor entry fluid-flow mass enters at the velocity and temperature defined by the HPC (and possible variable outlet guide vanes) via aperture E and then is diffused and slowed down by the diverging faces of the combustor entry, and then splits into three streams flowing into; upper bypass aperture F, lower bypass aperture H and rich-burn combustor aperture G. Combustor input CVG array 205 is added around the inside circumference of the entry aperture E at this expansion/diffusion entry point to; suppress duct flow-separations, lower drag and allow a more flow-efficient and/or more compact entry flow design, and this array is also applicable to prior art combustor duct surfaces.

The designed mass flow fraction in aperture G flows between the lower CVG combustor guide 213 and upper CVG combustor guide 225 where fuel is injected into the step and vortex filaments streaming from combustor lower (and upper) mixer CVG array 207, and this rich fuel mix further slows to the flame-front velocity in a downstream diffusing region of rich-burn aperture I, where initial rich-burning begins. The rich mix flame-front then exits after a predetermined time into lean-burn aperture J where extra bypass air is added and the combustion completes smoothly in an immediate second lean-burn step that then completes fuel oxidation, generating lower Nitrogen oxides. The final burn/oxidation of the fuel completes in the transit time to exit aperture K around output interface 202.

At the exit from aperture I, on CVG combustor guides 213 and 225 TE's, arrays of upper and lower flame stabilization tabs 216 act to trap and hold spanwise vorticies of burning fuel at the front and back faces of these tabs. The spanwise exit vorticies of the flame stabilization tabs 216 also act like as efficient lift and drag modifying Gurney tabs to further increase the TE downwash and help mix-down the bypass aperture air from ducts F and H into the volume of lean burn aperture J. Tab gaps 215 are added to also organize a fraction of chordwise rich-burning vortex filaments exiting into aperture J to mix with bypass air and complete the lean-burn cycle continuously. As with the LPT and fan blade LET, these flame stabilization tabs 216 may be angled and split other than perpendicular to the fluid-flow.

If the fluid-flow velocity increases at the combustor input (and then in aperture I's volume) the initial rich flame-front will retreat rearwards into the aperture I volume until the duct diffusion balances the local fluid speed to match the flame propagation speed at those physical conditions. This defines the minimum diffusion (surface curvature) required in the aft section of aperture I for flame stability, and at maximum flow velocities the flame front should be in front of the flame stabilization tabs 216 and TE exit. The ratio of sizes of apertures E, G and I effectively control the velocity of the fuel mix in the rich burn volume as related to the HPC output velocity. The ratio of apertures F and H to G controls the flow volume for rich-burn to bypass, cooling and lean-burn air for the combustor. The transverse vortex filaments on the front and rear faces of the mechanically robust flame stabilization tabs 216 also act as a very stable and flow disturbance-shielded backup ignition source when the igniter array 227 elements are turned off. Since the rich-burn volume generates a lot of heat on local flow surfaces and flame stabilization tabs 216 and TE, upper CVG cooling flow duct 226 and lower CVG cooling flow duct 212 are added adjacent to upper CVG duct body 224 and lower CVG duct body 214 respectively. The cooler fluid-flow in these upper and lower CVG cooling ducts are configured by the e.g. lower cooling entrance aperture 221 as defined by lower combustor guide 213 and lower CVG duct body 214. The exit cooling air from these CVG cooling flow ducts 226 and 212 angles into the mass inflows at aperture J. These cooling ducts are included in the body of the CVG combustor guides since these are thicker flow-control foils in the combustor ducting, but if these guide foils are sufficiently thin and cooling is adequate, the outer guide flow surface may cool these foils with no need for internal cooling ducts. Note that the combustor embodiment of the FIG. 11 a example is generally symmetric about its mid plane, so indicia detailing paired items are omitted in some cases to provide more drawing clarity, but are in fact present by the implicit symmetric design intent of this particular embodiment example.

The majority of the combustor energy release occurs in the fluid-flows in aperture J′s bounding volume, at the completion of fuel lean-combustion, so lower wall cooling surface 217 and upper wall cooling surface 220 are added to shield the combustor outside pressure surfaces from this intense heat, and these structures intercept a fraction of the fluid in ducts F and H as a film-cooling media. To protect the surfaces of instances of combustor output guide vane 204 at both sides, shields like side cooling surface 219 are added, and these also intercept entry fluid in ducts F and H (from before the CVG combustor body) as a film-cooling medium. Cooling surface 217, 220 and instances of 219 may employ well-known TBC on surfaces presented to aperture J's bounding volume, or may be fabricated as panels of CMC to reduce heat fluxes and oxidation damage, and may optionally employ drag reducing CVG arrays, like lower cooling surface CVG array 218 on both faces to lower drag. TBC prior art can also be employed over a fraction of e.g. combustor guide 213 and 225 surfaces to lower local heat fluxes into the combustor surfaces and this energy is then available in the combustor output into the HPT section for useful work. The duct-flow concepts of FIGS. 9a, 9b, 10a and 10b may also be optionally employed as refinements on any of the surfaces in this combustor to improve flows and reduce drag.

The pilot fuel plenum 208 and primary fuel flow plenum 211 are fed; filtered, pressurized and sequenced fuel-flows, and have separate angled pilot fuel jet 209 and primary fuel jet 210 that conduct fuel flows into the mixer CVG array 207 step regions. The pilot fuel jet 209 flow is smaller and may be injected closer to the CVG valley to ensure liquid fuel particle disruption and atomization by the intense step vortex filaments overcoming fuel viscosity and cohesion forces, and part of this rich fuel mix then streams to the CVG tip-vorticies and back to a region where the downstream velocity reduction to flame propagation velocity then allows ignition. In this way, it is possible to have high fluid-flow velocity at the mixer CVG array 207 step regions that provide high vortex mixing intensity and delay initial combustion heat till later in aperture I. When higher energy output is required, pressure in primary fuel flow plenum 211 similarly forces fuel via primary fuel jet 210 instances into the mixer CVG array 207 step regions. This example shows the angled primary fuel jet 210 located closest to the CVG tip regions and injects or sprays this fuel fraction into the highest vorticity filaments there, to be combusted. Using more than one fuel injection array, and sequencing and varying flow rates as needed allows a better tailoring of fuel flows to varying workloads or required exothermic heat generation. The actual jets may be in other configurations; sizes, geometry and instances and moved to different locations but still derive the benefit of improved low-drag fuel injection and mixing by using integrated CVG array vortices. The CVG arrays allow a low-drag way to add many combined smaller fuel-flow jets with intense mixing and liquid-particle breakup. This combustor can also employ fuel gasses such as natural gas (methane) or hydrogen etc., where the vorticity does not break up cohesive liquid droplets, but ensures best possible input-fluid/fuel mixing.

Liquid fuel flow vaporization-energy may be employed to balance the operational cooling of the; mixer CVG array 207 steps, fuel plenums, jets and adjacent regions and may be improved by modifying the fabrication, materials and design to control or separate downstream heat flux conduction etc.

FIG. 11b shows one cutaway section view example of this, as fabricating part of the downstream bodies of 213 and 225 and 216 etc., as an e.g. ceramic insert, ceramic after-body 228 with additional interface CVG array 229 embedded at the body transition after the fuel jets, to reduce heat conduction into the fuel plenums, or this downstream part facing into aperture I may be metal coated with TBC etc., to lower conduction through the interface CVG array 229 mating surface. An attached ceramic after-body 228 behind modified 213 and 225 foils, supporting the flows in aperture F and H ducts and rich burn aperture I allow a simplified design by removing need for CVG cooling flow ducts 226 and 212 etc. The igniter array 227 conductors can be integrated or wired into a ceramic or CMC body, or through holes from the core volume with e.g. a refractory metal like Tungsten, spark-discharging to a second conductor or a cooled wall section, and this provides a design that can sustain very high combustion temperatures. An angled additional combustor injection jet 230 is shown in the CVG step of interface CVG array 229 of the upper or outer surface of a ceramic after-body 228. Since the pressure in aperture F/H and aperture I can be varied and balanced, related to the input pressure of aperture E, it is possible to inject inlet bleed and cooling fluid from upstream to slightly pressurize the core of ceramic after-body 228, and then reject this cooling flow via instances of combustor injection jet 230 to also improve the BL momentum of the fluid-flows on aperture H and/or aperture I side of ceramic after-body 228. Instances of combustor injection jet 230 may also be applied to external duct surface entry CVG array 222 and internal duct surface CVG array 223. Instances of optional step-expansion grooves and/or step shear guide may be added to the ceramic after-body 228, but are not shown for drawing clarity.

FIG. 11b versions of modified 213 and 225 foils are shown as thin wall castings and fuel plenums, and these items may be solid or manufactured in any combination of fabrication methods to provide the correct flow geometries. Additional interface CVG array 229 may have its valleys and tips offset or a different pitch from mixer CVG array 207 to increase fuel mixing. Fuel injection pressure is controlled to ensure adequate jet flows at the required workload and any entering liquid fuels do not fall below their vapor pressure until exiting the fuel jets, so as not to vapor-lock liquid fuel flows.

Other instances of CVG arrays are included on other combustor surfaces as beneficial to decrease combustor drag, and the mixer CVG array 207 is shown as a visibly taller step structure, since it is primarily employed to ensure sufficient fuel mixing and related vortex turbulence, and has a secondary drag-reduction role. Mid-surface CVG array 206 and external duct surface entry CVG array 222 and internal duct surface CVG array 223, on upper and lower surfaces as appropriate are also optionally added to reduce overall surface drag from the flow surfaces and allow a wider latitude of Re values not inducing flow separation losses in the combustor and ducting surfaces.

It is possible to have more than one instance of pairs of combustor guide 213 and 225, or a single instance of combustor guide 213 (with possibly a ceramic after-body 228), arranged for best flows within a single combustor defined by outer combustor pressure wall 200, driving the design geometry etc. The core design may be modified from an essentially constant-radius (from engine shaft axes) planar sub-segment design shown in FIG. 11a, to a design with combustor guide 213 and 225/228 merging into circular symmetry (more like instances of venturi tubes), if this embodiment structure variant is more efficient for the available design volumes. Combustor guide 213 and 225 can also be configured radially to effectively have the mixer CVG array 207 aligned in a radial direction, and act similarly to combinations of high pressure turbine inlet stator vanes with included fuel injection apertures and combustion volumes. Instances of a CVG combustor design may be easily modified for other flow styles such as folded and reversing flow ducts and combustor paths as found on e.g. Allison 250, PW300 and other smaller sized turbine engines.

It is also possible to employ this CVG vortex flow-mixing strategy to improve flow and mixing interfaces and ducting/piping in other combustor styles such as, e.g. liquid-fuel and oxidizer combustors and feed centrifugal turbo-pumps (with optional integrated impeller CVG's) for applications such as a hydrogen/liquid oxygen rocket or thruster where some of the working fluids are possibly cryogenic prior to the flame front combustion points, and require careful mixing at high velocities before ignition and expansion through an exhaust nozzle to generate thrust. This type of combustor may be a mixer plate structure with flow injection holes, and these can have CVG's embedded on the circumferences to provide exit vortex filaments to improve combustion and mixing stability as fuel flows are throttled or varied.

A further combustor embodiment is a solid-fuel arrangement where the fuel is fixed within pressure containment or (effectively) a semi-closed duct/tube structure. Combustion progresses with an oxidizer integrally mixed in the solid fuel, or an introduced oxidizer flow (like the Rutan/Virgin Galactic engine using N20), and the energetic combustion products (effectively the input fluid-flow to be processed) are conducted through an exit nozzle output to form a thrust. The containment/duct walls and/or nozzle may be treated as for prior FIG. 10 duct CVG embodiments, to have CVG's to provide a low-drag exit flow surface-interface revealed as the fuel is consumed, and a TBC may be incorporated, along with added cooling jets, as for e.g. a HPT turbine blade. The surface drag losses and shocks on conventional conical/bell or commercial Aerospike style type exhaust nozzle flow surfaces may be improved and/or modified with CVG's configured for this. A hypergolic fuel mixing chamber acts like a combustor and also could use CVG's, or in attached nozzles.

The fuel feed lines, pumps, igniter's and other ancillaries etc., are not explicitly shown, as they are mostly standardized, and follow the general form and functions of the known prior art. FIG. 11a and 11b are representational and not to exact scale and the; aperture fluid-flow splitting and balances, fluid transit times, component sizes and instances and locations, may be modified widely as required to meet design goals for the operating environment and fuels etc., based on the fundamental concept of using drag-lowering integrated CVG's for improved; overall drag reduction, fuel atomization, and mixing in a compact, hi-performance, low-emissions and energy efficient combustor. FIGS. 11a and 11b could be of the general size of e.g. a CFM-56 combustor instance or segment, but can be scaled up or down in size and length etc., as required for a particular gas-generator application. If the total internal surface area of a new art conformal vortex combustor is configured as similar to a prior art combustor, this new art design allows a significant absolute drag reduction and losses over prior art designs, and the ability to design the duct path and foil sections for the correct divergence/diffusion and flow velocities to provide reliable combustion.

These surprisingly diverse ranges of types of high-temperature and/or high-stress embodiments as taught herein to improve device fluid-flows and energy efficiency are an unexpected outcome and capability of fundamentally integrated CVG applications that are simply not practical or possible with conventional prior art Vortex Generator approaches. All the cited embodiments and variations, at their most fundamental common level, employ novel Conformal Vortex Generator art to process or manipulate Newtonian fluid-flows to obtain a level of benefits such as improved energy efficiency and/or expanded control ranges, not possible with prior art.

Therefore, while the disclosed information details the preferred embodiments of the invention, no material limitations to the scope of the claimed invention are intended and any features and alternative designs that would be obvious to one of ordinary skill in the art are considered to be incorporated herein. Consequently, rather than being limited strictly to the features disclosed with regard to the preferred embodiment, the scope of the invention is set forth and particularly described in the following attached claims.

What is claimed is:

1. A method applied to a Newtonian fluid-flow aero/hydrodynamic processing device to improve operational energy efficiency and/or design fluid-flow control range, comprising:
(i) an input fluid source means to provide a source of said Newtonian fluid-flow, and conveying a portion of said input fluid source to,
(ii) a fluid-flow modifying surface employed by said Newtonian fluid-flow aero/hydrodynamic processing device with at least one conformal vortex generator means that processes at least part of said Newtonian fluid-flow, communicating a portion of this processed input fluid source to,
(iii) an output fluid delivery means to conduct said processed Newtonian fluid-flow to an output interface,
whereby application of said conformal vortex generator means allows a reduction of Newtonian fluid-flow energy losses and/or improves said fluid-flow control range, providing greater operational energy efficiency and/or design operating capability.

2. The method defined in claim 1 wherein said conformal vortex generator is an integrated conformal vortex generator that is integrally embedded in said fluid-flow modifying surface.

3. The method defined in claim 2 wherein said integrated conformal vortex generator is configured during the design and/or testing process for improved performance.

4. The method defined in claim 1 wherein said fluid-flow modifying surface is a member of the group comprising; a fluid-flow ducting means, a bypass-fan means, a compressor means, a pump means, a combustor means, a rotor foil, a stator foil, a propeller means or a turbine means, and employs at least one said conformal vortex generator means on said fluid-flow modifying surface to improve energy efficiency by reducing fluid-flow drag and/or extending an operating capability.

5. The method defined in claim 4 wherein said member of fluid-flow modifying surfaces employs the addition of an angled jet fluid injection port connected by a plenum means to a fluid source of suitable pressure, to inject fluid-flow and add additional momentum into a boundary layer downstream of said conformal vortex generator means.

6. The method defined in claim 5 wherein said angled jet fluid injection port is configured to provide resistance to clogging from debris and may optionally employ additional instances of fluid injection ports grouped for redundancy.

7. The method defined in claim 6 wherein said angled jet fluid injection port discharges into a fluid-flow injection cavity configured to inject fluid-flow momentum into lower boundary layers by benefiting from the velocity and/or pressure gradients induced downstream of said conformal vortex generator.

8. The method defined in claim 6 wherein said angled jet fluid injection port discharges fluid into a fluid-flow injection cavity configured to increase fluid spreading capability.

9. The method defined in claim 6 wherein said angled jet fluid injection port adds cool fluid into the boundary layer that acts to cool a surface downstream of said conformal vortex generator means.

10. The method defined in claim 4 wherein said member of fluid-flow modifying surfaces additionally employ a step-expansion groove and/or a step shear guide to improve effectiveness of said conformal vortex generator means.

11. The method defined in claim 4 wherein said member of fluid-flow modifying surfaces additionally employ a second conformal vortex generator means on a surface before a trailing edge, downstream of first said conformal vortex generator means, to further reduce drag and improve energy efficiency.

12. The method defined in claim 5 wherein said fluid source of suitable pressure connected by a plenum means to said angled jet fluid injection port is configured so said suitable pressure varies in sympathy with the fluid-flow velocity over said fluid-flow modifying surface to allow maximum jet fluid flow rate and momentum addition without risk of jet-liftoff.

13. The method defined in claim 4 wherein said member of fluid-flow modifying surfaces employs the addition of a conformal vortex generator means on a surface facing a gap between fluid-flow surfaces with relative motions that acts to impede fluid-flows through said gap and reduce energy losses and/or gap fluid-flow losses.

14. The method defined in claim 4 wherein said member of fluid-flow modifying surfaces employs said conformal vortex generator that is configured so debris entrained in said fluid-flows with sufficient energy to cause mechanical damage, tends to loft clear of a following surface so as to minimize downstream impacts and/or erosion damage.

15. The method defined in claim 2 wherein said integrated conformal vortex generator is configured to provide registration marks and reference alignment for the optional attachment of an ablative conformal vortex generator to provide a resulting combined conformal vortex generator with modified step height.

16. The method defined in claim 7 wherein said fluid-flow injection cavity connected to said angled jet fluid injection port connected by said plenum means to said fluid source of suitable pressure employs suction to withdraw fluid-flow from said lower boundary layers to improve downstream fluid-flow and benefits from the velocity and/or pressure gradients induced downstream of said conformal vortex generator.

17. The method defined in claim 16 applied to a fluid-flow body surface as a first fluid-flow injection cavity, angled jet fluid injection port and plenum instance employing suction, configured to communicate plenum fluid-flow to a second instance angled jet fluid injection port and fluid-flow injection cavity, located at a lower local-pressure area of said fluid-dynamic body surface, whereby fluid extracted from said first injection cavity instance is injected as a relative higher pressure fluid via said second injection cavity instance to improve said second instance downstream fluid-flow, and benefits from the velocity and/or pressure gradients induced downstream of the second instance conformal vortex generator, and improves body fluid-flow performance and energy efficiency.

18. The method defined in claim 4 wherein said combustor member of fluid-flow modifying surfaces is configured to combine integrated turbine input stator flow guidance surfaces to create a higher efficiency and/or more compact combustor design.

19. The method defined in claim 4 wherein said Newtonian fluid-flow aero/hydrodynamic processing device is a gas turbine engine that employs at least; a fluid-flow ducting means, a compressor means, a combustor means and a turbine means, wherein at least one included fluid-flow modifying surface employs a conformal vortex generator means to improve energy efficiency by reducing fluid-flow drag and/or extending operating capability.

20. The method defined in claim 4 wherein said combustor member of fluid-flow modifying surfaces is configured with the addition of a nozzle as an output fluid delivery means to form an exhaust fluid-flow that generates thrust.

21. The method defined in claim 20 wherein said nozzle forming an exhaust fluid-flow employs an additional conformal vortex generator configured to reduce exhaust fluid-flow drag and/or extend operating capability.

22. The method defined in claim 21 wherein with an associated angled jet fluid injection port adds cool fluid-flow into a boundary layer that acts to cool a downstream surface and benefits from the velocity and/or pressure gradients induced downstream of said conformal vortex generator applied to said nozzle.

23. The method defined in claim 2 wherein said conformal vortex generator means is configured to generate vortices that interact with and disrupt a fluid-flow shock wave to minimize shock wave energy losses.

24. The method defined in claim 1 wherein said Newtonian fluid-flow aero/hydrodynamic processing device employs at least; an input connection means connected to at least one integrated conformal vortex generator means in a duct or pipe that then connects to an output means to control fluid-flow drag and energy losses.

25. The method defined in claim 4 wherein said compressor and turbine members of fluid-flow modifying surfaces are combined to form a turbocharger embodiment.

26. The method defined in claim 4 wherein said fluid-flow ducting means member of fluid-flow modifying surfaces is configured as a flow-body with closed and/or open ends where application of said conformal vortex generator lowers drag forces and/or yaw-induced forces when in motion.

27. The method defined in claim 26 wherein said flow-body transitions to free-flight with a predetermined kinetic energy, so improved energy efficiency and/or fluid-flow dynamics allows extended range and/or path stability.

28. The method defined in claim 4 wherein said member of fluid-flow modifying surfaces employs said conformal vortex generator that is configured with varying geometries so that mechanical vibration modes and/or flexure are minimized.

29. The method defined in claim 4 wherein said fluid-flow ducting means additionally employs embossed walls on non-fluid control faces with wall-supporting root junction radii greater than those of a right angle junction, to configure a duct surface with optimized thermal conductivity and/or beam strength.

30. A Newtonian fluid-flow aero/hydrodynamic processing apparatus with improved operational energy efficiency and/or design fluid-flow control range, comprising:
(i) an input fluid source to provide a source of said Newtonian fluid-flow, and conveying a portion of said input fluid source to,
(ii) a fluid-flow modifying surface with at least one conformal vortex generator that processes at least part of said Newtonian fluid-flow, communicating a portion of processed input fluid source to,
(iii) an output fluid delivery that conducts said portion of processed input fluid source to an output interface,
whereby application of said conformal vortex generator allows a reduction of Newtonian fluid-flow energy losses and/or improves said fluid-flow control range, providing greater apparatus operational energy efficiency and/or design operating capability.

31. The apparatus defined in claim 30 wherein said conformal vortex generator is an integrated conformal vortex generator that is integrally embedded in said fluid-flow modifying surface.

32. The apparatus defined in claim 30 wherein said conformal vortex generator is configured to generate hydrodynamic vortex filaments that act to suppress cavitation bubble development to minimize damage and/or noise resulting from cavitation.
